(19) United States
(12) Patent Application Publication
(10) Pub. No.: US 2023/0279326 A1
(43) Pub. Date: Sep. 7, 2023

(54) CAPTURE ASSEMBLY AND METHOD OF USE THEREOF

(71) Applicant: Truvian Sciences, Inc., San Diego, CA (US)

(72) Inventors: Roger Taylor, San Diego, CA (US); Jeff Hawkins, San Diego, CA (US); Johnny Steve Rachele, San Diego, CA (US); Daniel Adam Trott, San Diego, CA (US); Peter Delmenico, San Diego, CA (US)

(21) Appl. No.: 17/925,791

(22) PCT Filed: May 18, 2021
(86) PCT No.: PCT/US2021/033013

§ 371 Date: Nov. 16, 2022

Related U.S. Application Data
(60) Provisional application No. 63/026,581, filed on May 18, 2020.

(51) Int. Cl. C12M 3/00; C12M 3/06; C12M 1/00

(52) U.S. Cl. CPC C12M 23/48; C12M 27/14; C12M 27/22

(57) ABSTRACT

The present disclosure provides a capture assembly optionally for use in an automated sample analyzer. The sample analyzer includes an optical assembly for scanning a sample well of a planar substrate, e.g., a multiwell plate that is loaded onto and secured to the capture assembly to perform an assay, e.g., detection of an analyte in the sample. The capture assembly automatically aligns the planar substrate about a rotational axis of a drive shaft and secures the substrate to the drive shaft to prevent unwanted movement or slippage of the substrate during starting, stopping and rotation of the substrate at varying rotational velocities thereby ensuring the sample well is reliably detected by the optical assembly.

### CROSS-REFERENCE TO RELATED APPLICATION(S)

This application claims the benefit of priority under 35 U.S.C. § 119(e) of U.S. Provisional Patent Application Ser. No. 63/026,581, filed May 18, 2020. The disclosure of the prior application is considered part of and is incorporated by reference in the disclosure of this application.

### BACKGROUND OF THE INVENTION

### Field of the Invention

The present invention relates generally to diagnostics and more specifically to a capture assembly for receiving, aligning and securing a planar substrate within an automated sample analyzer for optical analysis of the substrate at rotational velocity, as well as related methods of use to perform an assay.

### Background Information

Direct-to-consumer (DTC) diagnostics involves consumers (e.g., patients) directly accessing healthcare or wellness-related diagnostic tests and test results, without the need for a doctor's prescription. Recently, U.S. and international DTC diagnostics markets have expanded rapidly as a result of growing consumer interest in the tracking of personalized fitness, wellness, and healthcare-related information.

A key to the success of DTC diagnostics is the availability of robust technologies for testing a broad range of diagnostically meaningful analytes with accuracy, fast turnaround times, and at low-cost. While certain handheld or portable devices, such as blood glucose meters, or test strips, e.g., for urine analysis, have been developed to facilitate personalized medical testing (“bedside testing” or “point-of-care testing (POCT)”) by healthcare providers, there remains a need for technologies facilitating the reliable, rapid, and cost-effective analysis of multiple analytes, e.g., at a “point-of-customer-contact (POCC)” site, such as in a pharmacy or a general store.

Various conventional sample analyzers that utilize scanning optical detection modules to conduct diagnostic testing are known in the art. Some of these analyzers utilize a multiwell plate including sample wells that are continuously scanned as the plate is rotated about an axis such that multianalyte analyses can be performed.

Performing optical analysis of a multiwell plate which is being rotated at high rotational velocity presents several challenges. For example, the plate must be sufficiently secured to the rotation mechanism to ensure slippage of the plate is prevented during starting, stopping and rotation of the plate at variable rotational velocities. This ensures that the position of individual sample wells of the plate can be reliably detected by the optical assembly while the plate is undergoing rotational velocity.

Another challenge is ensuring that the plate is appropriately aligned with the optical assembly when loaded into the sample analyzer without the need for a clinical technician to perform burdensome and/or complex manipulations during the loading process.

Many approaches have been taken to address these challenges. However, there exists a continual need for new sample analyzer designs that prevent or mitigate these challenges.

### SUMMARY OF THE INVENTION

The present disclosure provides a capture assembly optionally for use in an automated sample analyzer. The sample analyzer includes an optical assembly for scanning a sample well of a planar substrate, e.g., a multiwell plate that is loaded onto and secured to the capture assembly to perform an assay, e.g., detection of an analyte in a sample. The capture assembly automatically aligns the planar substrate about a rotational axis of a drive shaft and secures the substrate to the drive shaft to prevent unwanted movement or slippage of the substrate during starting, stopping and rotation of the substrate at varying rotational velocities thereby ensuring the sample well is reliably detected by the optical assembly.

Accordingly, in one embodiment, the disclosure provides a capture assembly that includes a clamp mechanism and a drive shaft optionally coupled to a rotational motor. In certain aspects, the clamp mechanism is configured to clamp and secure a planar substrate and includes: i) a hub for contacting a bottom surface of the planar substrate, the hub having one or more elements disposed on an upper surface of the hub configured to engage the bottom surface of the planar substrate and position the planar substrate on the upper surface of the hub in a plane of rotation; and ii) a clamping portion configured to reversibly contact a top surface of the planar substrate. In some aspects, the clamping portion is operable to reversibly transition from a first configuration to a second configuration. When in the first configuration, the clamping portion is not in contact with the top surface of the planar substrate, and when in the second configuration, the clamping portion is in contact with the top surface of the planar substrate thereby clamping the planar substrate between the upper surface of the hub and the clamping portion. In certain aspects, the drive shaft has a longitudinal axis perpendicular to the plane of rotation, the shaft being operably coupled to the hub and operable to rotate the planar substrate in the plane of rotation by transfer of rotational force from the drive shaft to the hub and planar substrate.

In another embodiment, the disclosure provides a sample analyzer that includes the capture assembly the invention. In certain aspects, the sample analyzer includes an optical assembly having an illumination source and an illumination detector. In some aspects, the optical assembly is operable to irradiate a reaction mixture disposed within a well of a planar substrate attached to the clamp mechanism with light emitted from the illumination source and detect emission light from the reaction mixture via the illumination detector.

In yet another embodiment, the disclosure provides a method of conducting an assay. The method includes: a) placing a planar substrate having a well disposed within a perimeter of the substrate onto a support platform of the sample analyzer, wherein the well includes a reaction mixture including a sample and reagent; b) moving the capture assembly from the first position to the second position thereby causing the one or more elements of the hub to engage a bottom surface of the planar substrate and orient the planar substrate into the plane of rotation, and the clamping portion to transition from the first configuration to the second configuration to clamp the planar substrate between the one or more elements of the hub and the flange of the clamping portion; c) rotating the planar substrate within the plane of rotation; and d) detecting an analyte within the reaction mixture. In certain aspects, the analyte is detected using the optical assembly of the sample analyzer described herein.

In still another embodiment, the disclosure provides a method of securing a planar substrate to a drive shaft. The method includes: a) placing a planar substrate onto a support platform of a capture assembly of the disclosure; and b) moving the assembly from the first position to the second position thereby causing the clamping portion to transition from the first configuration to the second configuration to clamp the planar substrate between the one or more elements of the hub and the flange of the first member of the clamping portion. In certain aspects, the one or more elements of the hub engage the bottom surface of the planar substrate and automatically orient and/or align the planar substrate in the plane of rotation during transition of the assembly from the first position to the second position. In some aspects, the plane of rotation is perpendicular to the longitudinal axis of the drive shaft.

In another embodiment, the disclosure provides a method of securing a planar substrate to a drive shaft. The method includes: a) placing a planar substrate onto a support platform of a capture assembly of the disclosure; and b) moving the assembly from the first position to the second position thereby causing the clamping portion to transition from the first configuration to the second configuration to clamp the planar substrate between the one or more elements of the hub and the flange of the first member of the clamping portion and the flange of the third member of the clamping portion. In certain aspects, the one or more elements of the hub engage the bottom surface of the planar substrate and automatically orient and/or align the planar substrate in the plane of rotation during transition of the assembly from the first position to the second position. In some aspects, the plane of rotation is perpendicular to the longitudinal axis of the drive shaft.

### BRIEF DESCRIPTION OF THE FIGURES

FIG. 1A is a schematic showing the general architecture of the capture assembly in one aspect of the invention.

FIG. 1B is an expanded schematic of portions of the capture assembly in one aspect of the invention.

FIG. 2 is a side view of the clamp mechanism in one aspect of the invention.

FIG. 3 is a cross-sectional view of the clamp mechanism shown in FIG. 2.

FIG. 4 is an expanded view of the clamp mechanism shown in FIG. 2.

FIG. 5 shows the hub of a clamp mechanism about to engage a planar substrate in one aspect of the present invention.

FIG. 6 is a perspective view of a planar substrate shaped as a disc having sample wells arranged in concentric rings radially about the circumference of the disc in one aspect of the invention.

FIG. 7 is a top view of the planar substrate depicted in FIG. 6.

FIG. 8 is a bottom view of the planar substrate depicted in FIG. 6.

FIG. 9 is a cross-sectional view across the height and though the center of the planar substrate depicted in FIG. 6.

FIG. 10 is a cross-sectional view of clamp mechanism in one aspect of the present invention.

FIG. 11 is a magnified view of FIG. 10.

FIG. 12 is a cross-sectional view of clamp mechanism in one aspect of the present invention.

FIG. 13 is a schematic showing loading of a planar substrate onto a support platform in one aspect of the present invention.

FIG. 14 is a side view of the capture assembly in one aspect of the present invention.

FIG. 15 is a side view of the capture assembly in one aspect of the present invention.

FIG. 16 is a side view of the capture assembly in one aspect of the present invention.

FIG. 17 is a side view of the capture assembly in one aspect of the present invention.

FIG. 18 is a cross-sectional view of the clamp mechanism in one aspect of the present invention.

FIG. 19 is a cross-sectional view of the clamp mechanism in one aspect of the present invention.

FIG. 20A shows engagement of the planar substrate with the hub in one aspect of the present invention.

FIG. 20B shows engagement of the planar substrate with the hub in one aspect of the present invention.

FIG. 21 is a side view of the capture assembly in one aspect of the present invention.

FIG. 22 is a side view of the capture assembly in one aspect of the present invention.

FIG. 23 is a side view of the capture assembly in one aspect of the present invention.

FIG. 24 is a schematic showing the architecture of an optical assembly of the disclosure in one aspect of the invention.

FIG. 25 is a perspective view of the capture assembly in one aspect of the present invention in which the assembly is configured in a clam shell configuration.

FIG. 26A is a perspective view of the capture assembly in one aspect of the present invention.

FIG. 26B is a cross-sectional view of the capture assembly of FIG. 26A where the clamping portion is in an open configuration.

FIG. 26C is a cross-sectional view of the capture assembly of FIG. 26A where the clamping portion is in a closed configuration.

FIG. 27A is a magnified view of the capture assembly in one aspect of the present invention. The assembly includes three ball features 55 disposed on the hub 50 which engage snap features 56 on the bottom of the planar substrate 80.

FIG. 27B is a magnified view of the capture assembly in one aspect of the present invention. The assembly includes one ball feature 55 disposed on the hub 50 which engages features on the bottom of the planar substrate 80.

FIG. 28A is an expanded schematic of the capture assembly in one aspect of the present invention.

FIG. 28B is a side view of the capture assembly of FIG. 28A.

### DETAILED DESCRIPTION OF THE INVENTION

The present disclosure is based on an innovative capture assembly optionally for use in an automated sample analyzer. The capture assembly automatically aligns a planar substrate about a rotational axis of a drive shaft and secures the substrate to the drive shaft to prevent unwanted movement or slippage of the substrate during starting, stopping and rotation of the substrate at varying rotational velocities thereby ensuring the sample well is reliably detected by the sample analyzer.

Before the present compositions and methods are described, it is to be understood that this invention is not limited to particular assemblies, methods and experimental conditions described, as such assemblies, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “the assembly” or “the method” includes one or more assemblies, methods, and/or steps of the type described herein which will become apparent to those persons skilled in the art upon reading this disclosure and so forth.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

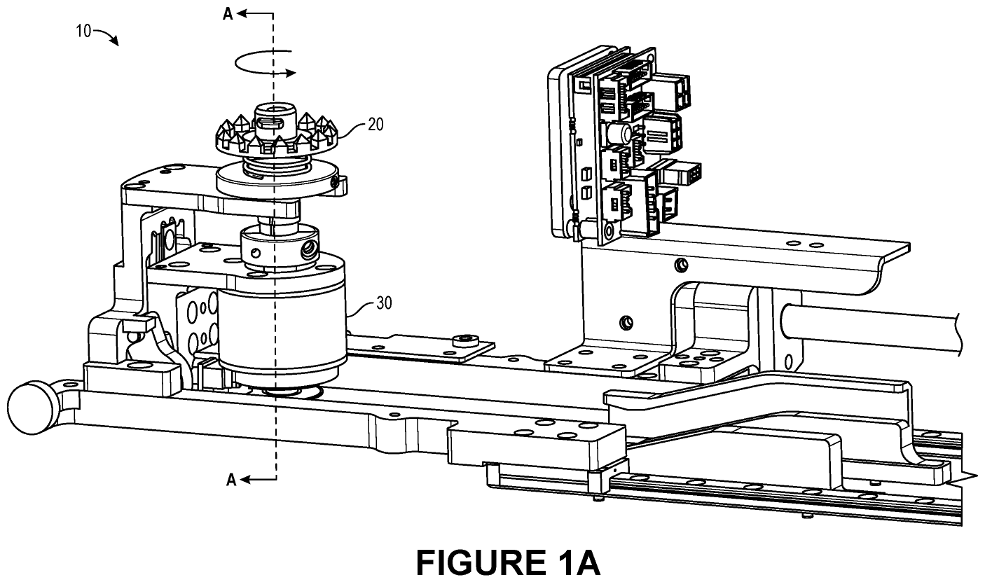

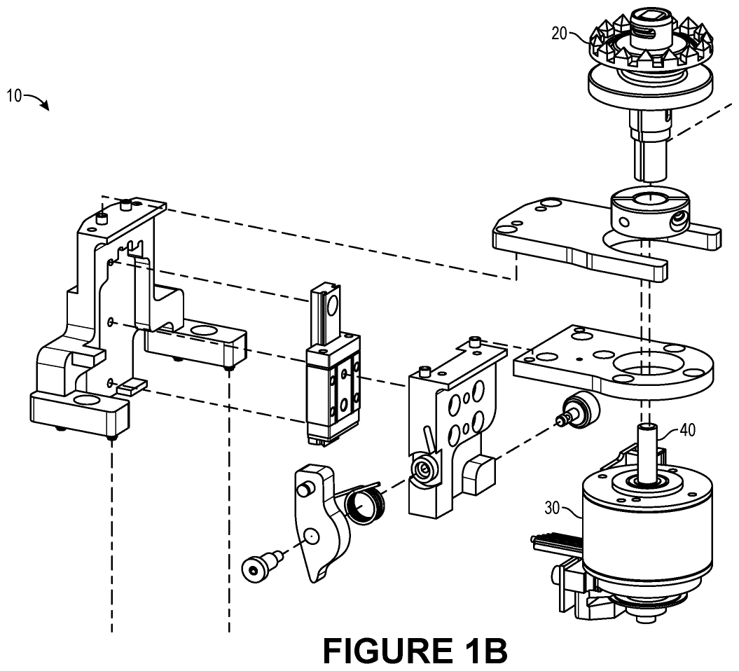

Accordingly, in one embodiment, the disclosure provides a capture assembly that includes a clamp mechanism and a drive shaft optionally coupled to a rotational motor. FIGS. 1A and 1B show a general overview of the assembly. As shown in FIG. 1A, the assembly 10 includes a clamp mechanism 20 and optionally a rotational motor 30. The rotational motor 30 is coupled to the clamp mechanism 20 via a drive shaft extending along the rotational axis (line A-A) of the motor. In FIG. 1A, the capture mechanism is shown in a first unclamped configuration in which portions of the clamp mechanism are disengaged and do not contact a planar substrate (not shown) that is to be coupled to the assembly as discussed further herein.

FIG. 1B shows an expanded view of the assembly 10 with the clamp mechanism 20 being oriented along the longitudinal axis of the drive shaft 40 such that the clamp mechanism 20 is operable to rotate about the rotational axis of the rotational motor 30.

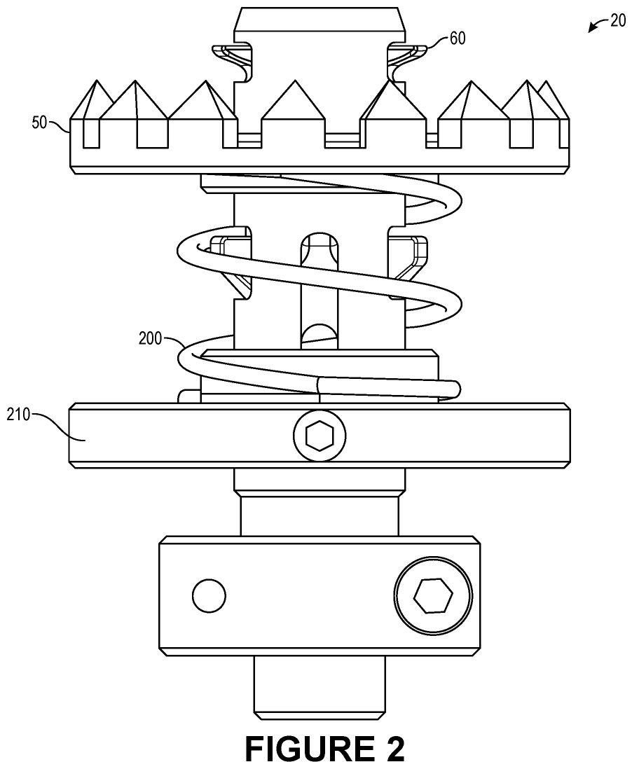

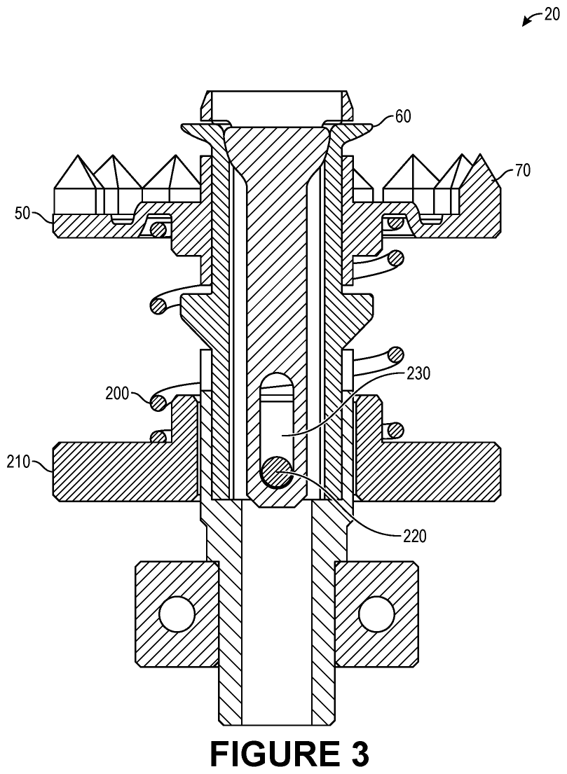

FIGS. 2-4 illustrate the claim mechanism depicted in FIGS. 1A and 1B. As shown, the clamp mechanism 20 includes a hub 50 and a clamping portion 60. The hub 50 is configured to contact a bottom surface of the planar substrate and optionally includes one or more elements 70 disposed on an upper surface of the hub. The one or more elements 70 are configured to engage the bottom surface of the planar substrate and automatically position and align the planar substrate on the upper surface of the hub 50 in a plane of rotation that is perpendicular to the rotational axis of the drive shaft and rotational motor. Again, the capture mechanism of FIGS. 2 and 3 is shown in a first unclamped configuration in which portions of the clamp mechanism 20 are disengaged and do not contact a planar substrate (not shown) that is to be coupled to the assembly as discussed further herein.

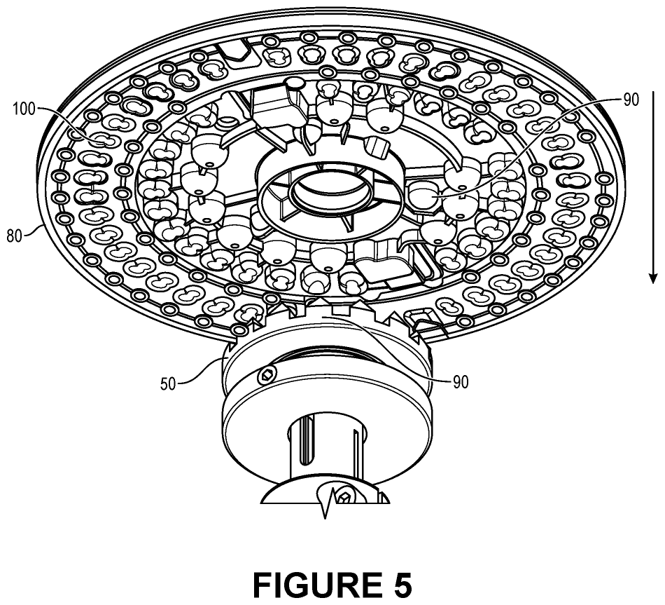

In use, the bottom surface of a planar substrate engages the hub. As shown in FIG. 5, one or more features 90 on the bottom surface of the planar substrate 80 engage the one or more elements 70 on the upper surface of the hub 50. In certain aspects, the features on the bottom surface of the planar substrate 80 and the elements 70 of the hub 50 are configured such that the planar substrate 80 is automatically positioned or otherwise oriented in an optimal plane of rotation about the rotational axis upon contact of the elements 70 with the features 90 on the bottom of the substrate 80. This ensures that the planar substrate 80 is properly oriented on the hub 50 before the substrate 80 is rotated at a high velocity and to ensure that a sample well 100 of the planar substrate 80 can be properly analyzed by an optical assembly of a sample analyzer while the substrate 80 is being rotated in the plane of rotation.

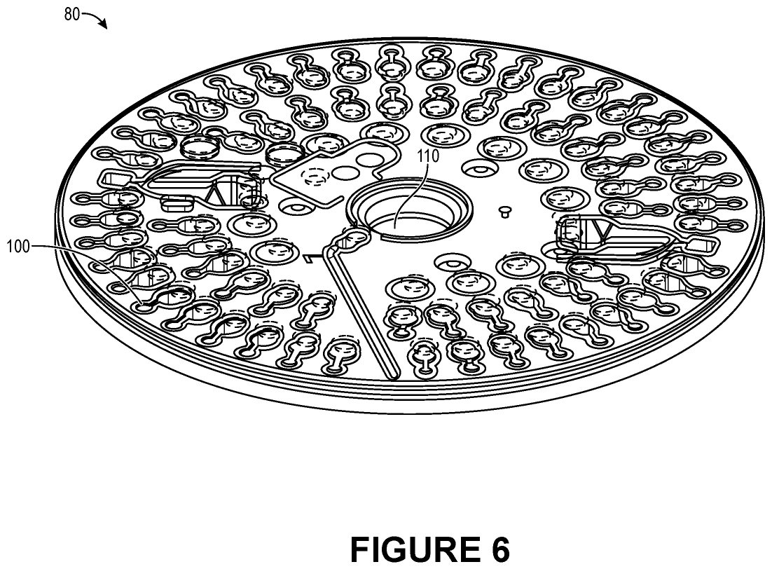

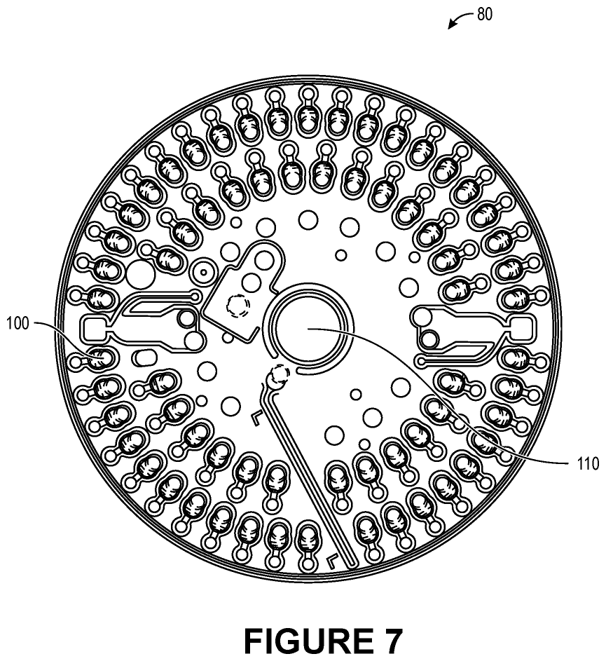

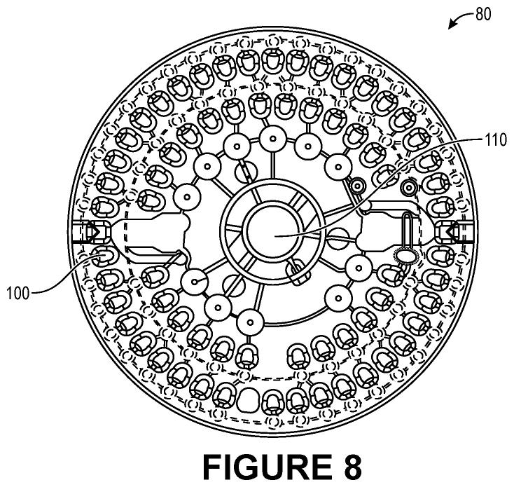

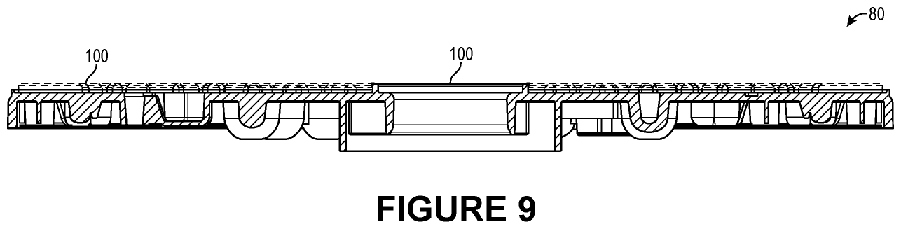

FIGS. 6-9 illustrate a planar substrate 80 for use with the capture assembly in one aspect of the present disclosure. The planar substrate 80 is shaped as a disc and has a multiwell format for performing different assays simultaneously. The planar substrate 80 includes a plurality of sample wells 100, each configured to hold a reaction mixture including a sample and reagent. As shown in FIGS. 6-8, the sample wells 100 are disposed within the circumference of the disc about the radius. A central through-hole 110 is disposed in the center of the disc. As shown in FIGS. 6-7, the sample wells 100 are arranged in concentric circles about the circumference of the disc such that as the disc is rotated about the plane of rotation, each sample well is irradiated with excitation light emitted from an illumination source of an optical assembly of the sample analyzer. In certain aspects, emission light from each irradiated sample well 100 is detected by an illumination detector of the optical assembly. In this manner, emission light from each sample well 100 can be continuously detected and recorded as the disc is rotated in the plane of rotation thereby allowing for an optical image to be generated corresponding to each sample well 100. Emission light can also be detected at the conclusion of discrete movements that align a sample well 100 with illumination and detection.

As discussed further herein, the clamping portion is configured to reversibly contact a top surface of the planar substrate. In some aspects, the clamping portion is operable to reversibly transition from a first unclamped configuration to a second clamped configuration. When in the first unclamped configuration, the clamping portion is not in contact with the top surface of the planar substrate, and when in the second configuration, the clamping portion is in contact with the top surface of the planar substrate or a surface of a through-hole of the planar substrate thereby clamping the planar substrate between the upper surface of the hub and the clamping portion or otherwise securing the planar substrate to the hub.

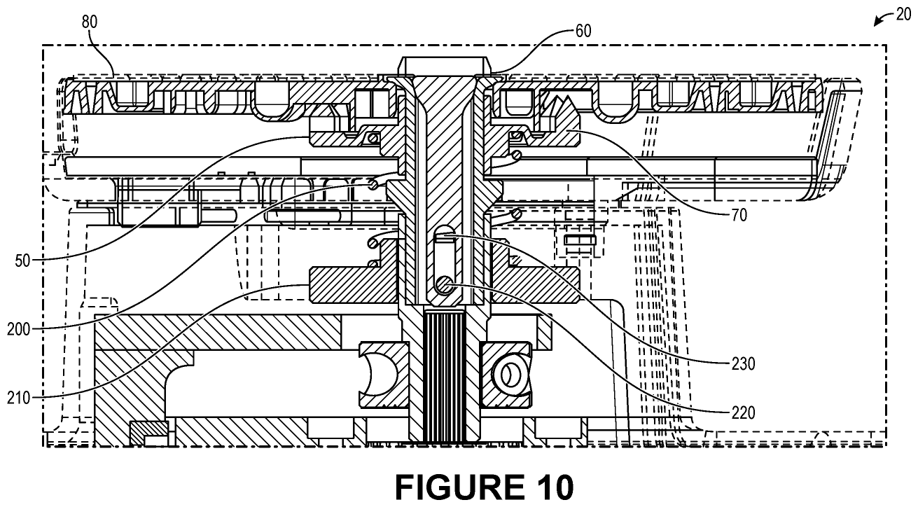

FIG. 10 is a cross-sectional view of the clamp mechanism 20 with the clamping portion 60 being in the second configuration. In the second configuration, the planar substrate 80 is compressed or otherwise clamped between the hub 50 and one or more members of the clamping portion 60.

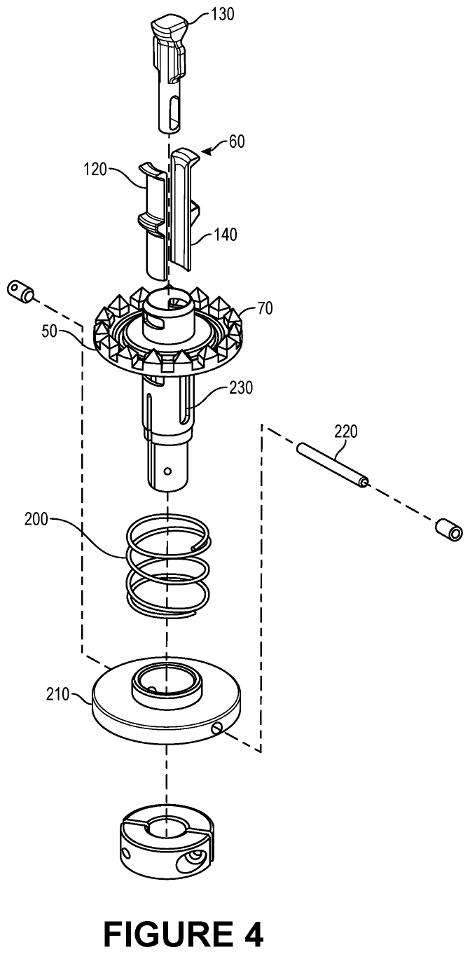

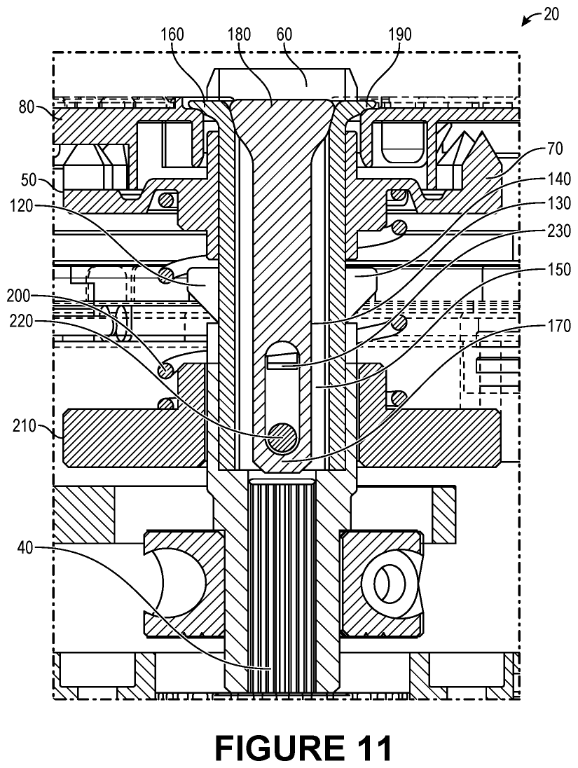

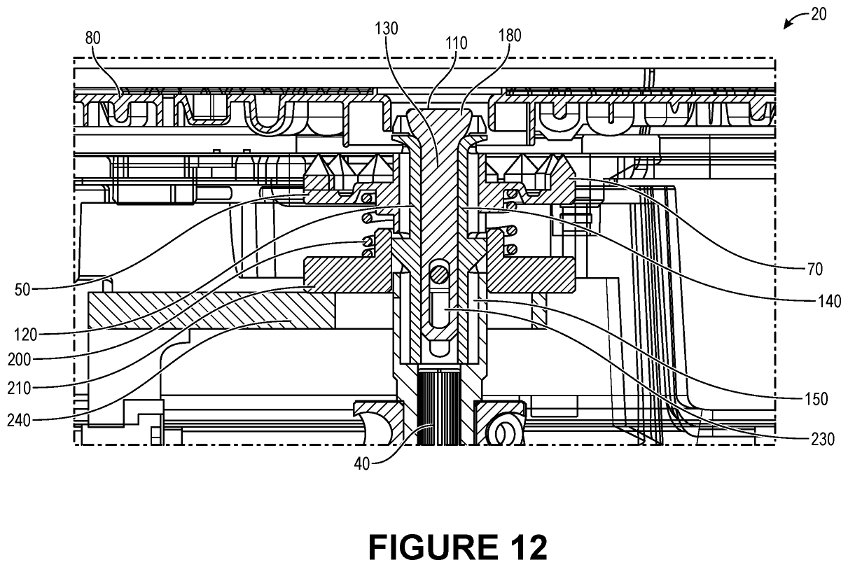

FIG. 11 is a magnified view of the clamp mechanism 20 depicted in FIG. 10. In certain aspects, the clamping portion 60 includes three clamping members (120, 130, 140). The clamping members are also shown in FIG. 4. As shown in FIG. 12 the hub 50 has a central tube 150 extending through the hub along the longitudinal axis (line A-A) of the shaft (not shown). The first member 120 has a flange 160 that contacts the top surface of the planar substrate 80 when the clamping portion 60 is in the second configuration. The second member 130 includes a shaft 170 that extends along the longitudinal axis of the drive shaft 40 and has an expanded diameter region 180 configured to contact the first member 120 and exert a compressive force on the planar substrate 80 between the hub 50 and the flange 160 of the first member 120. The third member 140 has a flange 190 that contacts the top surface of the planar substrate 80 when the clamping portion 60 is in the second configuration. The expanded diameter region 180 is configured to contact the third member 140 and exert a compressive force on the planar substrate 80 between the hub 50 and the flange 190 of the third member 140. In some aspects, in the second configuration, the expanded diameter region 180 simultaneously contacts and exerts a force on the first member 120 and the third member 140 to clamp the planar substrate 80.

While the present disclosure illustrates a clamp mechanism that includes a clamping portion having 3 members, it will be appreciated that clamping can be achieved using more or less than three members. In various aspect, the clamping portion may include 1, 2, 3, 4, 5, 6, 7, 8, 9 10 or clamping members. For example, the clamping portion may have a single member having an annular flange operable to clamp the planar substrate. In another aspect, the clamping portion may include 2 members, a first having a flange and second being operable to exert a force on the first to clamp a planar substrate.

In various aspects, the clamping force is generated by a spring as shown in FIGS. 2-4, 10 and 11. The spring 200 is disposed between the bottom of the hub 50 and a spring platform 210 which is positioned below the hub 50 on the clamp mechanism 20. A dowel 220 traverses a through slot 230 of the second member 130 and is rigidly connected to the spring platform 210 which translates force from the spring 200 to the second member 130 causing the expanded diameter region 180 of the second member 130 to exert a downward force on the first and third members (120, 140) and thus the top surface of the planar substrate 80 in the second configuration.

In various aspects, the clamping portion 60 is transitioned from a first disengaged configuration to a second clamped configuration. FIG. 12 shows the clamping portion 60 in the first disengaged configuration. In the first configuration, the spring 200 is compressed between the bottom of the hub 50 and the spring platform 210 which causes the expanded diameter region 180 of the second member 130 to be raised above the first and third members (120, 140) such that no downward force is exerted by the second member 130 on the first or third members (120, 140) and the clamp is disengaged.

In certain aspects, in the first configuration, the first and third members (120, 140) are oriented toward the central axis of the hub central tube 150 and the flanges of the first and third members (120, 140) are in a retracted position such that the terminal region of the clamp mechanism 20 above the hub 50 can traverse the central through-hole 110 of the planar substrate 80. The spring 200 is held in compression by a clamp release arm 240 which exerts an upward force on the bottom of the spring platform 210 causing the expanded diameter region 180 of the second member 130 to be raised above the first and third members (120, 140) and the flanges of the first and third members (120, 140) to be retracted toward the central axis of the hub central tube 150.

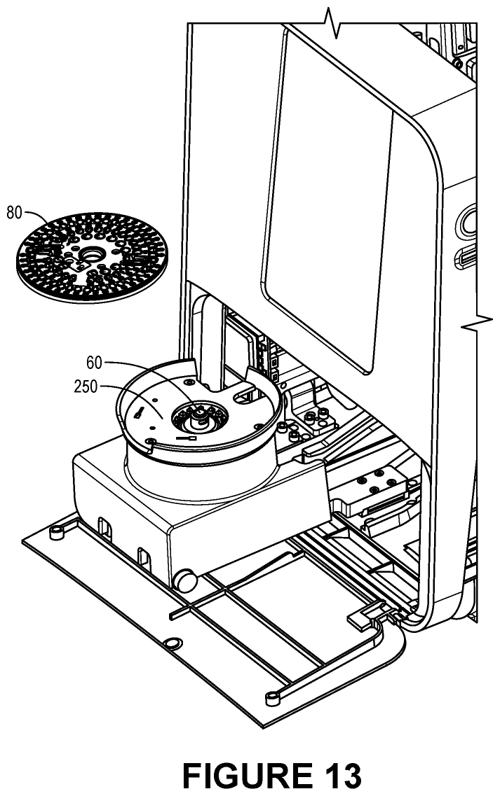

In certain aspects, the assembly further includes a support platform for supporting the planar substrate before the planar substrate is engaged by the assembly. As shown in FIG. 13, the support platform 250 is positioned above the clamp mechanism 20. The clamping portion is in the first disengaged configuration. In practice, a planar substrate 80, e.g., multiwell plate, is placed on the support platform 250, e.g., by a technician or medical worker.

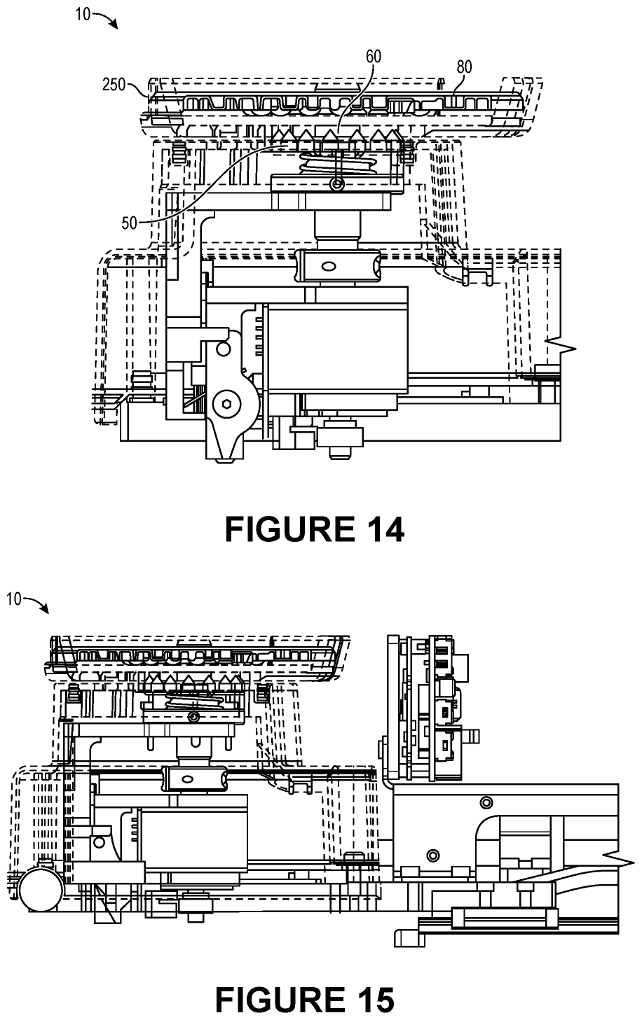

FIG. 14 shows the assembly 10 with a planar substrate 80 loaded onto the support platform 250. The clamping portion is shown in the first disengaged configuration. In certain aspects, the assembly 10 is operable to reversibly transition from a first position to a second position. FIG. 14 shows the assembly in the first position with the clamping portion also being in the first configuration. In some aspects, when the assembly 10 is in the first position, the clamping portion 60 is in the first configuration. As shown in FIG. 14, in the first position, the support platform 250 is in contact with the planar substrate 80 and the hub 50 is not in contact with the planar substrate 80. The planar substrate 80 is positioned on the support platform 250 above the hub 50 and the clamping portion 60.

From the first position, the assembly 10 is moved to a second position which causes the hub to engage the bottom of the planar substrate 80 and the clamping portion to transition from the first disengaged configuration to the second configuration thereby clamping the planar substrate and securing the planar substrate to the assembly 10 in a plane of rotation perpendicular to the rotational axis of the rotational motor. Upon transition of the assembly 10 to the second position, the clamping portion is in the second configuration thereby clamping the planar substrate as discussed herein and the planar substrate is no longer in contact with the support platform.

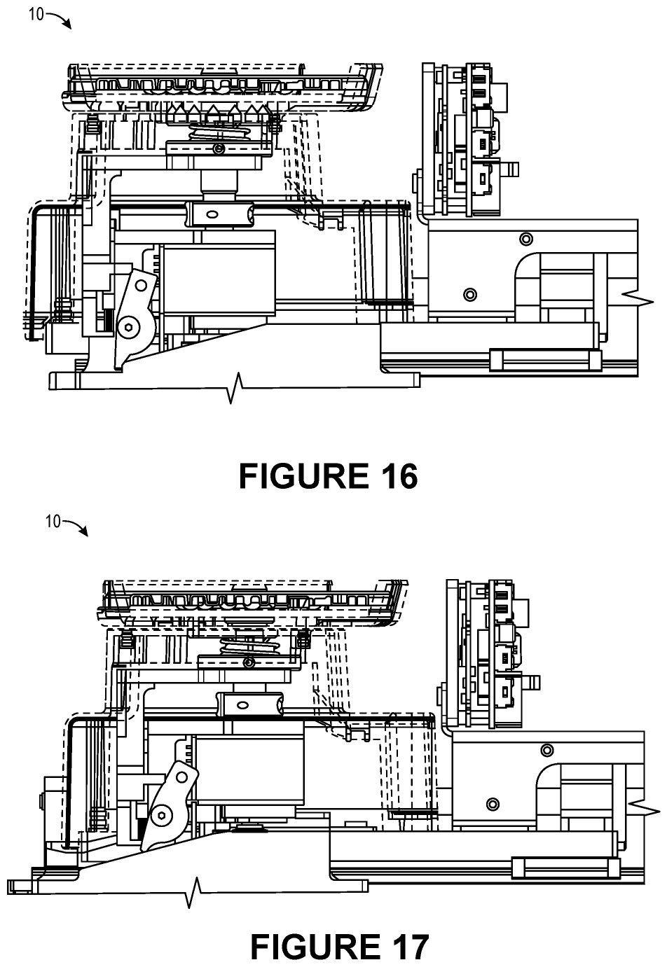

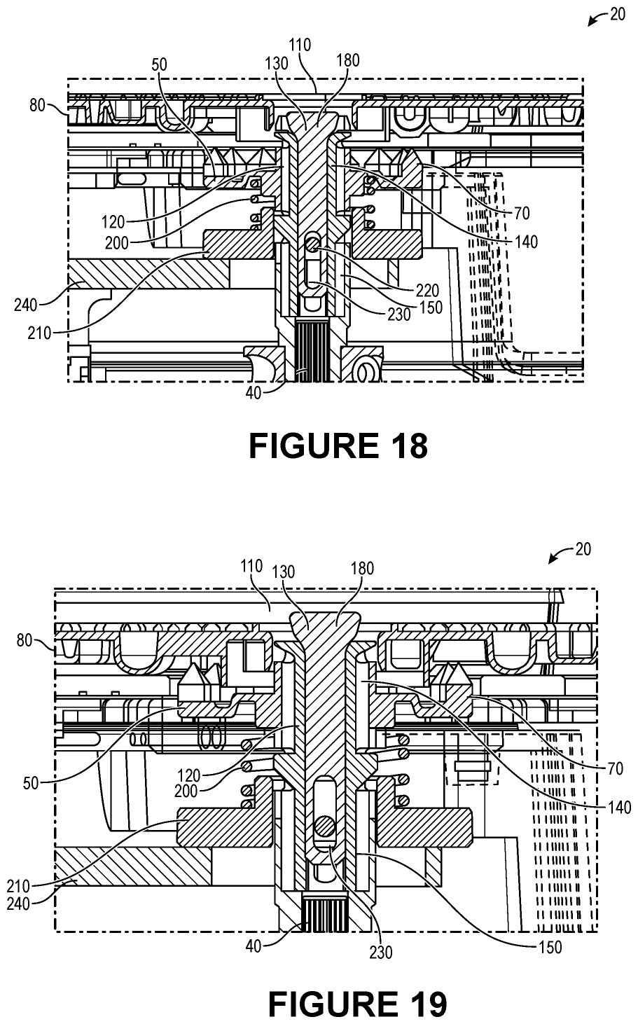

In operation, as the assembly is transitioned from the first position to the second position, the clamping portion is transitioned from the first configuration to the second configuration. In certain aspects, moving the assembly from the first position to the second position causes the clamping portion to transition from the first configuration to the second configuration. In some aspects, during transition from the first position to the second position, the assembly is raised such that the hub engages the bottom surface of the planar substrate and the clamping portion is moved through the center through-hole of the planar substrate while the clamping portion is in the first configuration. FIGS. 15-17 show the transition of the assembly from the first position through to the engagement stage when the hub is engaged with the bottom of the planar substrate and the clamping portion traverses the center through-hole of the planar substrate. Corresponding magnified views of FIGS. 15-16 are shown in FIG. 18 and FIG. 19 is a corresponding magnified view of FIG. 17.

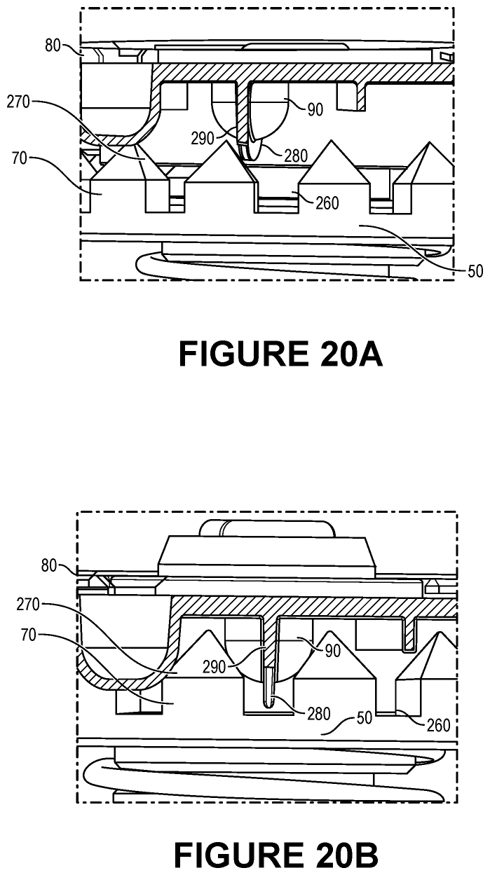

In certain aspects, as the assembly is raised in the Z direction and comes into contact with the bottom surface of the planar substrate, the planar substrate is aligned in a plane of rotation perpendicular to the longitudinal axis of the drive shaft. This is accomplished by engagement of the features on the bottom of planar substrate and the elements disposed about the hub. This is illustrated in FIGS. 20A and 20B which shows elements 70 engaging features 90 as the assembly is moved in the Z direction. The elements 70 shown are configured as projections extending from the surface of the hub 50 in the Z direction and spaced about the circumference of the hub 50 within the perimeter of the hub surface. The elements 70 are equally spaced about the circumference of the hub 50 with a gap 260 being formed between adjacent elements 70. The tip of each element includes sloped surfaces 270 forming a terminal point.

It will be appreciated that the elements 70 may have a variety of geometric shapes and sizes. For example, an element may have a cross sectional shape that is circular, ellipsoid, oval, triangular, rectangular, square, pentagonal and the like including any polygonal shape. Further, the element may have two more cross sectional shapes in different regions of the element. Similarly, the hub may include any number of elements that can be arranged in a variety of patterns. For example, the hub may include 1, 2, 3, 4, 5, 6, 7, 8, 9, 10, 11, 12, 13, 14, 15, 16, 17, 18, 19, 20 or more elements. The elements may be arranged in any format on the surface of the hub so as to form gaps between the elements or otherwise provide a structure for engaging one or more features on the bottom of a planar substrate that facilitates alignment of the substrate on the hub.

Similarly, the one or more features 90 on the bottom of the planar substrate may have a variety of geometric shapes and sizes. For example, a feature may have a cross sectional shape that is circular, ellipsoid, oval, triangular, rectangular, square, pentagonal and the like including any polygonal shape. Further, the feature may have two more cross sectional shapes in different regions of the feature. Similarly, the planar substrate may include any number of features that can be arranged in a variety of patterns on the bottom surface of the substrate or within a through-hole of the substrate. For example, the planar substrate may include 1, 2, 3, 4, 5, 6, 7, 8, 9, 10, 11, 12, 13, 14, 15, 16, 17, 18, 19, 20 or more features. The features may be arranged in any format on the surface of the substrate for engaging one or more elements on the hub that facilitates alignment of the substrate on the hub.

With reference to FIGS. 20A and 20B, in use, each feature 90 on the bottom surface of the planar substrate 80 is guided into a gap 260 via the sloped surfaces 270 thereby orienting the planar substrate 80 in a plane of rotation that is perpendicular to the longitudinal axis of the drive shaft. The features 90 on the bottom surface of the planar substrate 80 are spherical bumps. Each spherical bump includes a tip 280 projecting from the surface of the bump. The tip 280 includes a narrow strip of material 290 that extends along the surface of the bump perpendicular to the axis of rotation. In certain aspects, as the assembly is moved in the Z direction to engage the planar substrate 80, the tip 280 contacts the sloped surface 270 of the element 70 and is guided into the gap 260 to align or otherwise orient the planar substrate 80 in a plane perpendicular to the longitudinal axis of the drive shaft.

In one aspect, the bottom surface of the planar substrate includes 3 features arranged radially about the central through-hole equidistant from each other. In this aspect, each feature is shaped as shown in FIGS. 20A and 20B.

In certain aspects, to assist in aligning the planar substrate, the hub is slowly rotated to facilitate contact between the elements 70 of the hub 50 and the features 90 of the bottom surface of the planar substrate 80.

Once the planar substrate 80 is aligned on the hub 50 in a plane perpendicular to the longitudinal axis of the drive shaft, the planar substrate 80 is compressed between the hub 50 and members of the clamping portion 60 by transitioning the clamping portion 60 to the second configuration. In some aspects, this is accomplished by continued movement of the assembly from the first position to the second position.

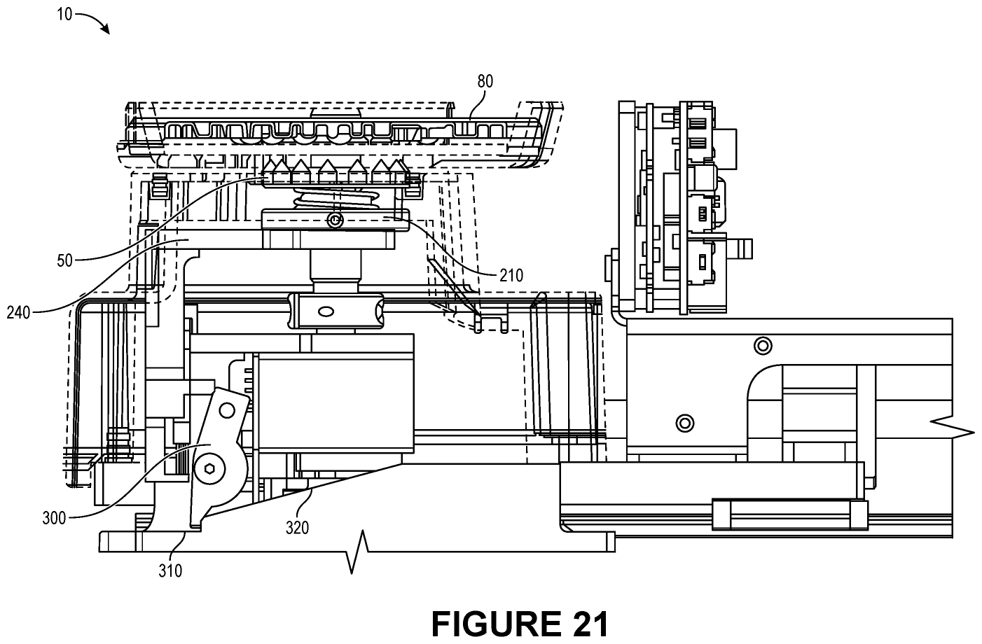

With reference to FIGS. 21-23, continued movement of the assembly 10 toward the second position causes the clamp release arm 240 to disengage thereby allowing the spring 200 to expand and transition the clamping portion from the first configuration to the second configuration. As shown in FIGS. 21-23, in certain aspects, disengagement of the clamp release arm 240 is caused by release of the drive hub clamp 300 which is in operable connection to the clamp release arm 240. When the assembly 10 is in the first position as shown in FIGS. 21, the drive hub clamp 300 is engaged causing the clamp release arm 240 to be engaged with the spring platform 210 and the clamping portion 60 to be in the first configuration.

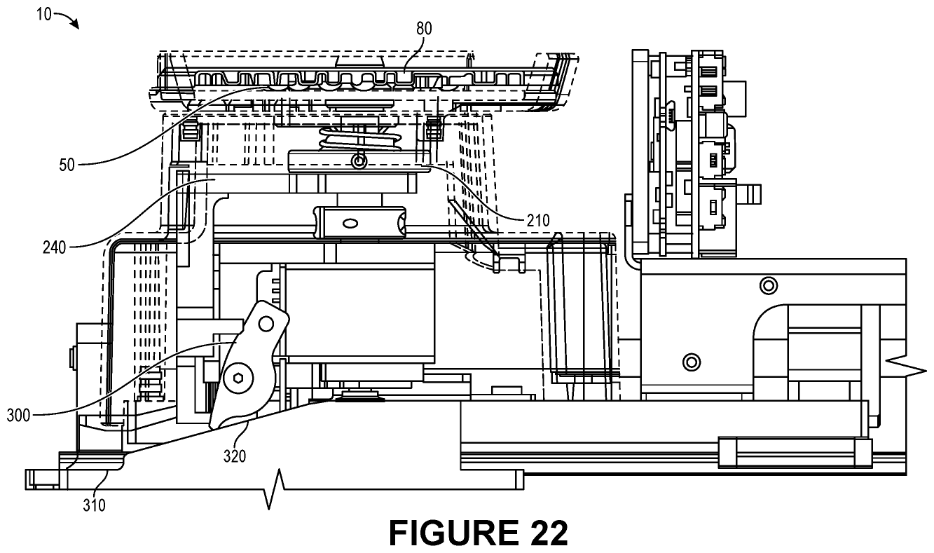

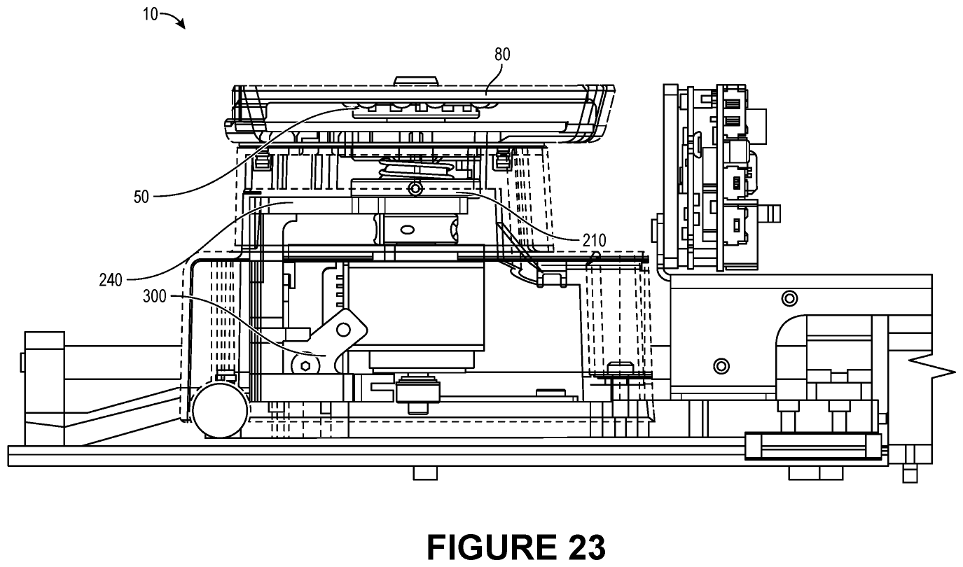

As the assembly 10 is moved from the first position to the second position, the drive hub clamp 300 is released via interaction with a catch surface 310 disposed on a sloped cam profile 320 of the assembly 10. FIG. 22 shows the assembly 10 in an intermediate position between the first position and the second position in which the drive hub clamp 300 is being disengaged as the assembly 10 is moved in the horizontal direction along the X axis. In certain aspects, the drive hub clamp 300 is held in the engaged position by a torsional spring that exerts a force on the drive hub clamp 300 to urge the drive hub clamp 300 to engage the clamp release arm 240. As the assembly 10 is moved horizontally, the drive hub clamp 300 is progressively disengaged as the drive hub clamp 300 traverses the sloped cam profile 320 causing the clamping portion to transition from the first configuration to the second configuration. Simultaneously, the assembly 10 is moved vertically by traversing a sloped cam profile thereby moving the hub 50 upward in the Z direction to engage and align the planar substrate 80 on the hub 50. As shown in FIG. 23, once the assembly 10 is moved to the second position, the clamping portion is in the second configuration and the planar substrate 80 is clamped to the hub 50 in a plane perpendicular to the longitudinal axis of the drive shaft (line A-A).

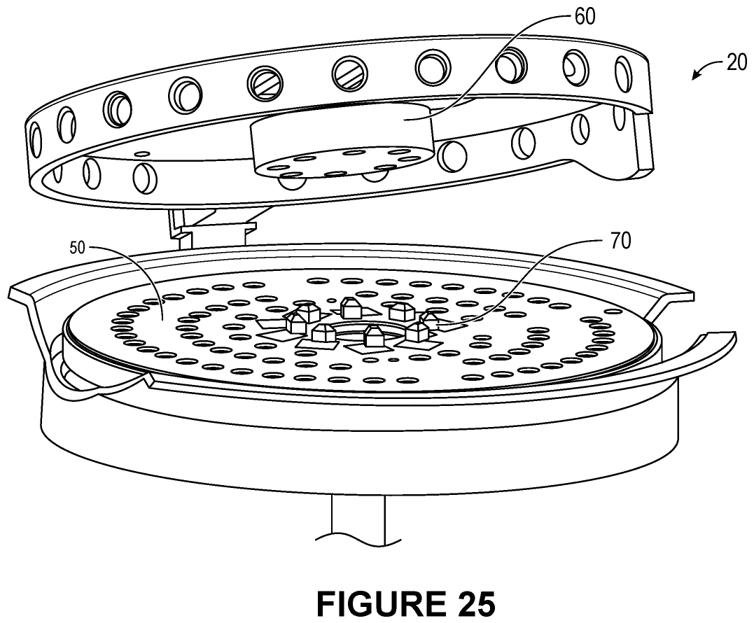

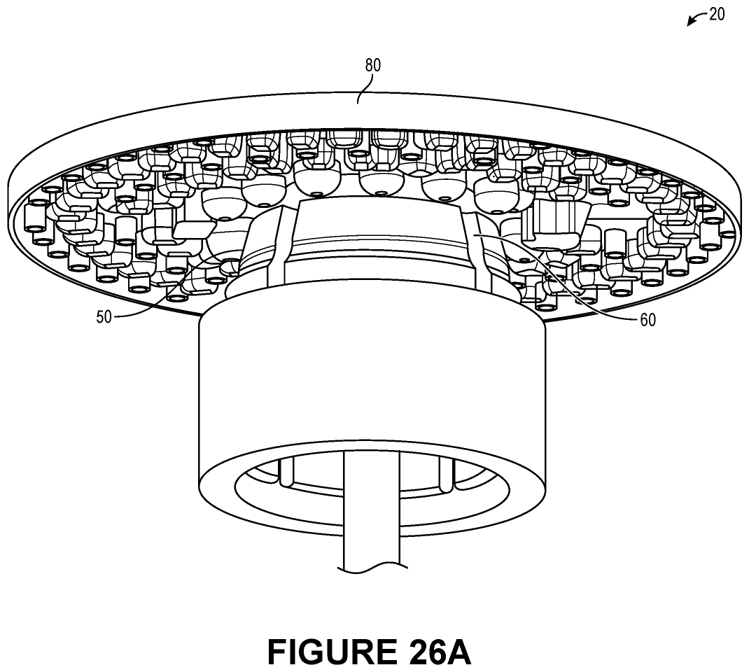

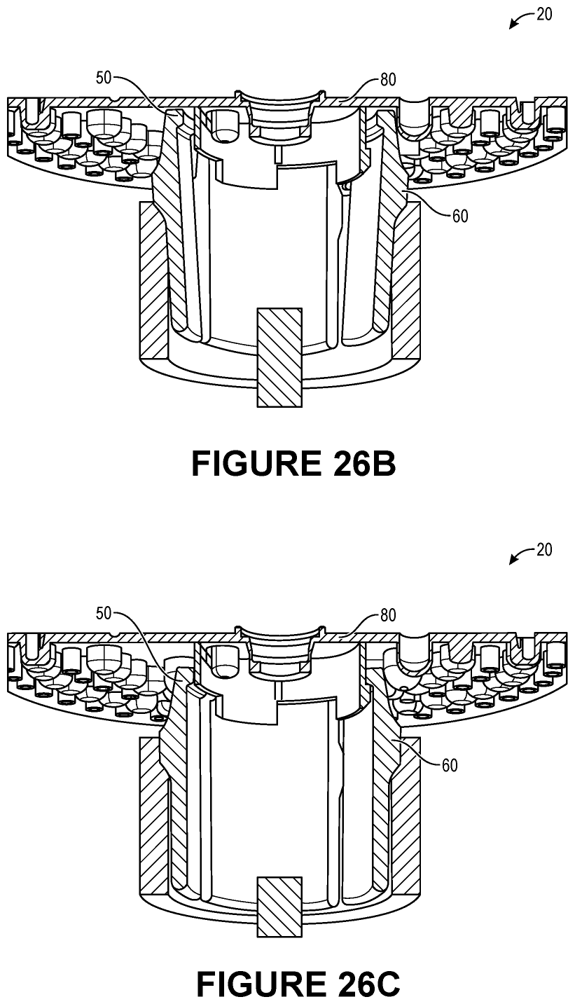

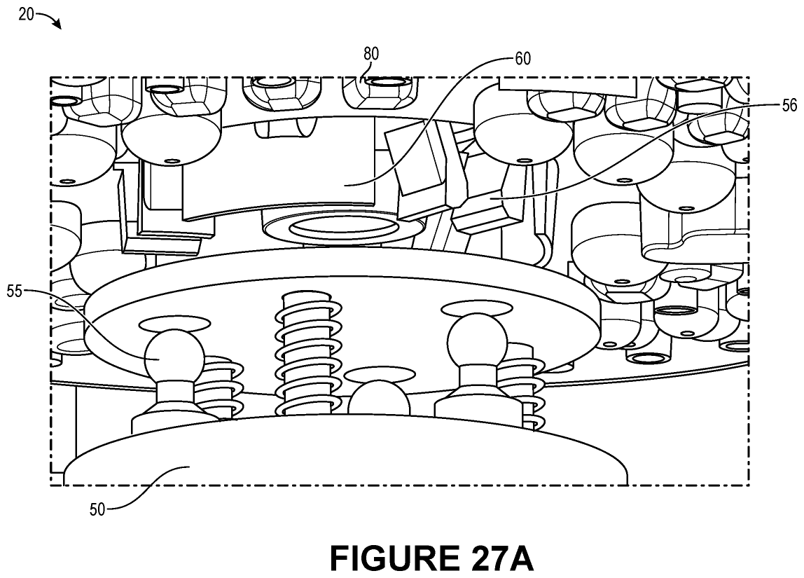

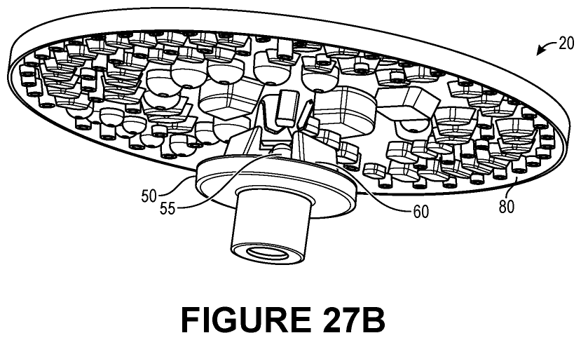

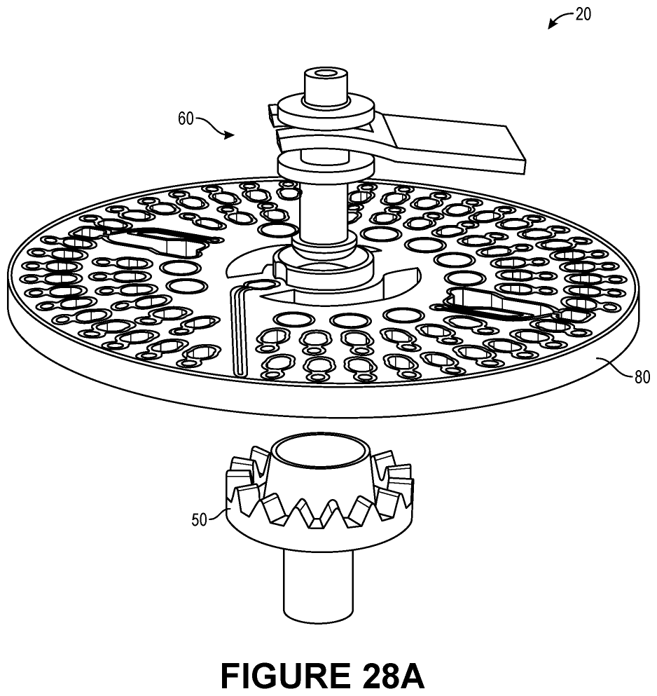

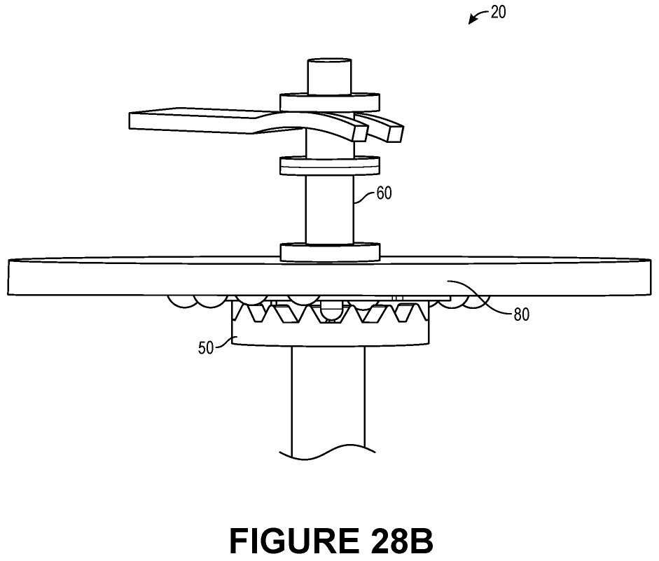

While the disclosure illustrates the capture assembly with reference to FIGS. 1-23, the invention may also include those capture assembly configurations and concepts depicted in FIGS. 25-28.

In another embodiment, the disclosure also provides a method of securing a planar substrate to a drive shaft. The method includes: a) placing a planar substrate onto a support platform of a capture assembly of the disclosure; and b) moving the assembly from the first position to the second position thereby causing the clamping portion to transition from the first configuration to the second configuration to clamp the planar substrate between the one or more elements of the hub and the flange of the first member of the clamping portion and the flange of the third member of the clamping portion. In certain aspects, the one or more elements of the hub engage the bottom surface of the planar substrate and automatically orient and/or align the planar substrate in the plane of rotation during transition of the assembly from the first position to the second position. In some aspects, the plane of rotation is perpendicular to the longitudinal axis of the drive shaft.

In various aspects, the capture assembly includes one or more processors operably coupled to the rotational motor to control rotation of the planar substrate. The capture assembly may also include one or more additional motors or actuators optionally coupled to the processor that control the movement of the capture assembly between the first position to the second position.

In certain aspects, once the planar substrate is clamped and the assembly is moved to the second position, the substrate is rotated about the rotational axis. In some aspects, the rotational motor is operable to start, stop or vary rotational velocity of the planar substrate between about 0 to 12,000 revolutions per minute (RPMs), including about 1,000, 2,000, 3,000, 4,000, 5,000, 6,000, 7,000, 8,000, 9,000, 10,000, 11,000 or 12,000.

In certain aspects, once the planar substrate is clamped and the assembly is moved to the second position, the substrate is rotated and the wells of the planar substrate are optically analyzed. As such, in another embodiment, the disclosure provides a sample analyzer that includes the capture assembly the invention. In certain aspects, the sample analyzer includes an optical assembly having an illumination source and an illumination detector. In some aspects, the optical assembly is operable to irradiate a reaction mixture disposed within a well of a planar substrate held by the clamp mechanism with light emitted from the illumination source and detect emission light from the reaction mixture via the illumination detector.

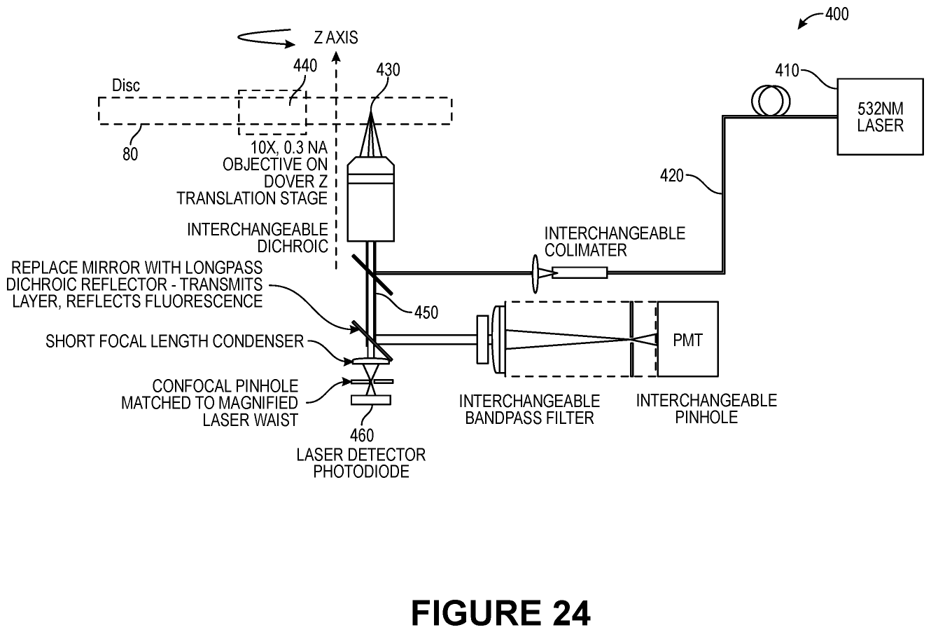

FIG. 24 is a schematic showing the general architecture of the optical assembly 400 in certain aspects of the invention. With reference to FIG. 24, the optical assembly 400 includes an illumination source 410 that emits excitation light 420 which is directed and focused at a focal point 430 within the plane of rotation 440 thereby irradiating a reaction mixture within a well of the planar substrate 80. Emission light 450 from the reaction mixture is then directed to an illumination detector 460 of the optical assembly 400. As such, in certain aspects, the optical assembly 400 has an illumination source 410 and an illumination detector 460 and is operable to irradiate the reaction mixture with excitation light 420 emitted from the illumination source 410 and detect emission light 450 from the reaction mixture via the illumination detector 460. The optical assembly 400 is configured to generate a coincidence of the focal points 430 of the illumination and detection light paths on the plane of rotation 440 of the planar substrate 80. As shown in FIG. 24, the plane of rotation 440 is generally perpendicular to the optical axis of light emitted from the illumination source 410 that traverses the plane of rotation 440.

In another embodiment, the disclosure provides a method of conducting an assay. In certain aspects, the method includes: a) placing a planar substrate having a well disposed within a perimeter of the substrate onto a support platform of the sample analyzer, wherein the well includes a reaction mixture including a sample and reagent; b) moving the capture assembly from the first position to the second position; c) rotating the planar substrate within the plane of rotation; and d) detecting an analyte within the reaction mixture. In certain aspects, the analyte is detected using the optical assembly of the sample analyzer described herein.

In yet another embodiment, the disclosure provides a method of conducting an assay. In certain aspects, the method includes: a) placing a planar substrate having a well disposed within a perimeter of the substrate onto a support platform of the sample analyzer, wherein the well includes a reaction mixture including a sample and reagent; b) moving the capture assembly from the first position to the second position thereby causing the one or more elements of the hub to engage a bottom surface of the planar substrate and orient the planar substrate into the plane of rotation, and the clamping portion to transition from the first configuration to the second configuration to clamp the planar substrate between the one or more elements of the hub and the flange of the clamping portion; c) rotating the planar substrate within the plane of rotation; and d) detecting an analyte within the reaction mixture. In certain aspects, the analyte is detected using the optical assembly of the sample analyzer described herein.

In some aspects, the sample analyzer of the present disclosure may further include one or more imaging devices operably coupled to the processor and/or the optical assembly. As used herein, an imaging device include any device or detector capable of capturing an image including, but not limited to a camera, CCD camera, photodiode, photomultiplier tube, laser scanner and the like.

In various aspects of the invention, the capture assembly is configured to rotate a planar substrate having one or more sample wells disposed within the perimeter of the planar substrate. In certain aspect, the planar substrate includes a plurality of wells, thereby defining a multiwell plate. In some aspects, the multiwell plate can facilitate the parallel performance of two or more different assay formats (e.g., a fluorescence and absorbance based format) or to facilitate the performance of different assays for two or more different analytes in a sample (e.g., a high-abundance and a low-abundance analyte). Each different well can differ with respect to one or more properties affecting the performance of an assay, e.g., a biochemical assay or a cell-based assay, such as an optical property, geometry or shape, dimension, surface property, or assay reagent content. Typically, the properties of the different wells are selected to improve the performance of a specific assay format or of an assay of a given format for a specific analyte.

As used herein, the term “well,” when used in connection with the planar substrate provided herein, refers to a well for performing an analytical assay to determine the concentration of an analyte of interest. In this context the term “well” is used synonymously with “assay well” and “sample well.”

The different wells on a multiwell plate can differ with respect to any property affecting the performance of an assay. The performance of an assay can be affected, e.g., with respect to the assay's sensitivity of analyte detection (e.g., lower limit of detection), robustness (e.g., Z-factor), signal intensity (e.g., absolute signal or relative to a positive or negative control), background signal (e.g., signal of a negative control well without analyte of interest), signal-to-noise ratio (S/N), signal variability (e.g., standard deviation of positive or negative control wells), reproducibility, temperature or light-sensitivity, sensitivity to interference from certain chemicals (e.g., fluorescent compounds, colored compounds, oxidizing or reducing compounds, detergents) or another factor.

In some aspects, the property of a well affecting the performance of an assay includes the well geometry (e.g., cube, rectangular cuboid or rectangular prism, sphere, cylinder, (inverted) pyramid, (inverted) cone, flat bottom, conical bottom, and the like), a well dimension (e.g., height, length, depth, or volume), an optical property of the well (e.g., light transparency or color), a surface property (e.g., high-binding (e.g., high protein-binding, high nucleic acid-binding), low-binding (e.g., low protein-binding, low nucleic acid-binding, beads in wells), cell-adhesion or cell-proliferation promoting, porous (e.g., glass filter or PVDF membrane) or non-permeable), temperature (e.g., room temperature, elevated or reduced temperature), or assay reagent content (e.g., assay reagents dried in a well or assay reagents in solution).

Two or more wells can be arranged on a multiwell plate in a variety of different arrangements. In some embodiments, the wells are arranged in columns and rows (e.g., forming a rectangle or a square). In some aspects, the wells are arranged in a circle or concentric circles arranged about the center of the circle. In some embodiments, the arrangement of the wells on the multiwell plate is encoded on a barcode (e.g., a two- or three dimensional barcode) on the multiwell plate.

While the present disclosure illustrates use of a disc shaped planar substrate, it will be appreciated that the planar substrate can be any geometric shape in which a sample well may be included and rotated. For example, the planar substrate may be any polygonal shape when viewed along the rotational axis such as, by way of illustration but in no way limiting, a triangle, square, rectangle, pentagon, hexagon, heptagon, octagon, nonagon, decagon, dodecagon and so forth. Similarly, it will be appreciated that the planar substrate may be arcuate or special shape when viewed along the rotational axis, such as, by way of illustration but in no way limiting, a circle, irregular circle or ellipse. Further it will be appreciated that the perimeter of the planar substrate when viewed along the rotational axis may include any number of arcuate portions, straight portions, grooves or recesses.

In some aspects, the planar substrate 80 includes a plurality of wells configured for an absorbance-based assay and/or a fluorescence-based assay. Wells configured for an absorbance-based assay can include, e.g., a clear or translucent bottom, as well as a clear or translucent bottom.

In some aspects, the planar substrate may include 2 or more, 3 or more, 4 or more, 5 or more, 6 or more, 7 or more, 8 or more, 9 or more, 10 or more, 15 or more, 20 or more, 25 or more, 30 or more, 35 or more, 40 or more, 45 or more, 50 or more, 60 or more, 70 or more, 80 or more, 90 or more, or 100 or more wells.

In certain aspects, a planar substrate provided herein includes a “clear” or “translucent” bottom in one or more wells. As used herein, the terms “clear” or “translucent” are used to describe a material that at least partially transmits light of a wavelength of interest in a ultraviolet or visible range, e.g., between 220 nm and 850 nm, between 300 nm-850 nm, between 400 nm-800 nm, or between 300 nm-700 nm. By contrast, a material referred to herein as “opaque” or “solid” (e.g., solid black or solid white) is a material that transmits essentially no light of a wavelength of interest in the ultraviolet or visible range. In some aspects, a clear or translucent well or multiwell plate bottom transmits at least 1%, at least 3%, at least 5%, at least 10%, at least 20%, at least 30%, at least 40%, at least 50%, at least 60%, at least 70%, at least 80%, or at least 90% of light hitting the surface of the bottom in the sample analyzer provided herein. In some aspects, at least 1%, at least 3%, at least 5%, at least 10%, at least 15%, at least 20%, at least 25%, at least 30%, at least 40%, at least 50%, at least 60%, at least 70%, at least 80%, at least 90%, at least 95%, or 100% of wells of the multiwell plate include a clear or translucent bottom. In some aspects, some or all of the wells on the peripheral circle of wells on a circular multiwell plate include a clear, or translucent bottom. In some aspects, only wells on the peripheral circle of wells on a circular multiwell plate comprise a clear or translucent bottom.

In certain aspects, an inner surface of a sample well of the planar substrate, may be functionalized. A surface may be referred to as “functionalized” when it includes a linker, a scaffold, a building block, or other reactive moiety attached thereto, whereas a surface may be “nonfunctionalized” when it lacks such a reactive moiety attached thereto.

A functionalized surface may refer to a surface having a functional group. A functional group may be a group capable of forming an attachment with another functional group. For example, a functional group may be biotin, which may form an attachment with streptavidin, another functional group. Illustrative functional groups may include, but are not limited to, aldehydes, ketones, carboxy groups, amino groups, biotin, streptavidin, nucleic acids, small molecules (e.g., for click chemistry), homo- and hetero-bifunctional reagents (e.g., N-succinimidyl(4-iodoacetyl) aminobenzoate (STAB), dimaleimide, dithio-bis-nitrobenzoic acid (DTNB), N-succinimidyl-S-acetyl-thioacetate (SATA), N-succinimidyl-3-(2-pyridyldithio) propionate (SPDP), succinimidyl 4-(N-mafeimidomethyl)-cyclohexane-1-carboxylate (SMCC) and 6-hydrazinonicotimide (HYNIC), and antibodies. In some instances, the functional group is a carboxy group (e.g., COOH).

The functional groups on a surface may be different for different regions of the surface. The functional groups on the surface may be the same for all regions of the surface. For example, the entire internal surface of a sample well may include the same functional group. Alternatively, different regions of the internal surface of a sample well may include different functional groups. Further, only portions of a surface may include functional groups.

Addition of functional groups to a surface may be utilized to form capture regions on the surface to immobilize or bind an analyte. In this manner, a specific analyte may be concentrated at a specific region of the surface to increase detection and/or analysis of the analyte. In one aspect, the inner surface of a well is functionalized to include an antigen or probe for binding an analyte. In another aspect, the inner surface of a well is functionalized to capture a bead optionally having a fluorescently labeled moiety to improve capture efficiency, spacing (for resolution and imaging purposes) and or control density. This may also be accomplished through other types of capture mechanisms, such as physical texturing or chemical based capture.

Functionalizing the surface of a well allows for use of inclusion of structures such as gold or silver nanoparticles to enhance the intensity of the emitted radiation for the reaction mixture. This is advantageous to the system architecture as it would reduce optical power requirements and enable use of lower cost light sources.

In some aspects, the multiwell plate includes one or more pluralities of wells configured for an absorbance based assay and one or more different pluralities of wells configured for a fluorescence based assay. In some aspects, one or more pluralities of wells configured for the absorbance based assay are arranged in a circle of wells on the periphery of a circular (e.g., disk shaped) multiwell plate. In some aspects, the wells arranged on the periphery of a circular multiwell plate have a diameter of between 0.5 mm and 3.0 mm (e.g., 1.5 mm). In some aspects, the wells arranged on the periphery of the circular multiwell plate include between about 1 to 8, 12, 24 or 48 wells, or between about 36 to 48 wells. In some aspects, the one or more pluralities of wells configured for an absorbance based assay include one or more pluralities of wells configured for a cell-based assay (e.g., RBC assay). In some aspects, the one or more pluralities of wells configured for an absorbance based assay include one or more pluralities of wells configured for a biochemical assay. In some aspects, the one or more pluralities of wells configured for a biochemical assay include one or more pluralities of wells configured for a homogeneous assay (e.g., protein detection, such as general protein absorbance (280 nm) or hemoglobin absorbance 540 nm-600 nm range (e.g., hemoglobin, oxyhemoglobin, carboxyhemoglobin, methemoglobin)). In some aspects, the one or more pluralities of wells configured for a biochemical assay include one or more pluralities of wells configured for a heterogeneous assay (e.g., ELISA). In some aspects, the one or more pluralities of wells configured for a fluorescence-based assay include one or more pluralities of wells configured for a fluorescence-based cellular assay. In some aspects, the fluorescence-based cellular assay can assay suspension cells, cells adhered to beads, or cells adhered to a well bottom. In some aspects, the one or more pluralities of wells configured for a fluorescence-based assay include one or more pluralities of wells configured for a fluorescence-based biochemical assay. In some aspects, the one or more pluralities of wells configured for a fluorescence-based biochemical assay include one or more pluralities of wells configured for a homogeneous fluorescence-based biochemical assay (e.g., an enzymatic substrate-turnover assay). In some aspects, the one or more pluralities of wells configured for a fluorescence-based biochemical assay include one or more pluralities of wells configured for a heterogeneous fluorescence-based biochemical assay (e.g., ELISA). In some aspects, the heterogeneous fluorescence-based biochemical assay involves analyte binding to a bead surface or well surface.

In some aspects, the multiwell plate includes one or more pluralities of wells configured for a cell-based assay and one or more different pluralities of wells configured for a biochemical assay. In some aspects, the one or more pluralities of wells configured for a cell-based assay include one or more pluralities of wells configured for a fluorescence-based cellular assay. In some aspects, the fluorescence-based cellular assay can assay suspension cells or cells attached to the surface of a bead or well. In some aspects, the one or more pluralities of wells configured for a cell-based assay include one or more pluralities of wells configured for an absorbance-based cellular assay. In some aspects, the one or more pluralities of wells configured for a biochemical assay include one or more pluralities of wells configured for a homogeneous biochemical assay. In some aspects, the one or more pluralities of wells configured for a homogeneous biochemical assay include one or more pluralities of wells configured for a homogeneous fluorescence-based biochemical assay. In some aspects, the one or more pluralities of wells configured for a homogeneous biochemical assay include one or more pluralities of wells configured for a homogeneous absorbance-based biochemical assay. In some aspects, one or more pluralities of wells configured for a biochemical assay include one or more pluralities of wells configured for a heterogeneous biochemical assay. In some aspects, the plurality of wells configured for a heterogeneous biochemical assays include one or more pluralities of wells configured for a fluorescence-based heterogeneous biochemical assay. In some aspects, the one or more pluralities of wells configured for a heterogeneous biochemical assay include one or more pluralities of wells configured for an absorbance-based heterogeneous biochemical assay. In some aspects, one or more of the pluralities of wells configured for an absorbance based assay are arranged in a circle of wells on the periphery of a circular (e.g., disk shaped) multiwell plate. In some aspects, the wells arranged on the periphery of a circular multiwell plate have a diameter of between about 0.5 mm and 3.0 mm (e.g., 1.5 mm). In some aspects, the wells arranged on the periphery of the circular multiwell plate include between about 1 to 8, 12, 24 or 48 wells, or between about 36 to 48 wells.

In some aspects, the multiwell plate includes two or more different pluralities of wells configured to analyze two or more analytes selected from a small molecule analyte (e.g., a monosaccharide, fatty acid, salt, drug), a large molecule analyte (e.g., a protein, phospholipid, nucleic acid), and a cell (e.g., a red blood cell, a white blood cell).

In some aspects, the multiwell plate includes one or more pluralities of wells configured for an assay for detecting a cell (e.g., RBC, WBC, circulating cancer cell (CTC), bacterial cell), and one or more different pluralities of wells configured for an assay for detecting a large molecule analyte (e.g., a protein analyte). In some aspects, the multiwell plate includes one or more pluralities of wells configured for an assay for detecting a cell (e.g., a RBC, a WBC, a circulating cancer cell (CTC), a bacterial cell), one or more different pluralities of wells configured for an assay for detecting a large molecule analyte (e.g., a protein analyte), and one or more different pluralities of wells configured for an assay for detecting a small molecule analyte (e.g., glucose or cholesterol).

In some aspects, the multiwell plate includes one or more pluralities of wells configured for an assay for detecting a high abundance analyte (e.g., albumin, glucose or a RBC) and one or more different pluralities of wells configured for an assay for detecting a medium- or low-abundance analyte (e.g., tumor necrosis factor alpha or a CTC).

In some aspects, the multiwell plate has a circular shape (e.g., disc shape) or an ellipsoid shape. In some aspects, the multiwell plate has a square or rectangular shape.

In some aspects, one or more of the different pluralities of wells include one or more reagents for a biochemical assay. In some aspects, the biochemical assay includes turnover of an enzyme substrate. In some aspects, the biochemical assay includes binding of a binding reagent (e.g., antibody) to an analyte of interest (e.g., insulin, cytokine, or the like). In some aspects, reagents for a biochemical assay include an enzyme or an enzyme substrate. In some aspects, the enzyme substrate is a fluorescent substrate (i.e., a substrate that can change its fluorescence properties as a result of enzyme-mediated turnover). In some aspects, the enzyme substrate can change its absorbance characteristics in the ultraviolet (e.g., 200 nm-400 nm) or visible spectrum (e.g., 350 nm-850 nm) as a result of enzyme-mediated turnover. In some aspects, the biochemical assay is a binding assay (e.g., sandwich-immune assay, ELISA, or the like). In some aspects, the biochemical assay is a competition assay (e.g., immunoassay for a steroid hormone). In some aspects, the biochemical assay is a homogeneous assay (e.g., (TR-)FRET assay, enzyme-substrate turnover assay, or the like). In some aspects, the biochemical assay is as heterogeneous assay (e.g., ELISA). In some aspects, the biochemical assay is a kinetic assay (e.g., continuous-read or intermittent-read). In some aspects, the biochemical assay is an endpoint assay. In some aspects, the biochemical assay reagent is coated on the surface of a plurality of wells (e.g., a capture or binding reagents, such as an antibody, streptavidin, protein A, protein G, aptamer, oligonucleotide capture probe, or the like). In some aspects, the biochemical assay reagent is a dried reagent (e.g., to facilitate long-term storage). In some aspects, the biochemical assay reagent is in solution (e.g., dissolved in an aqueous buffer or an organic solvent).

In some aspects, one or more of the different pluralities of wells include one or more reagents for a cell-based assay. In some aspects, the cell-based assay includes binding of a binding reagent (e.g., a fluorescence-labeled antibody) to a cell-surface marker (e.g., CD20, CD45, or the like). In some aspects, reagents for a cell-based assay include a labeled cell-specific binding reagent (e.g., a fluorescence-labeled anti-CD20 antibody) or a bead coated with a cell-specific binding reagent (e.g., an antibody directed to a cell-surface marker, e.g., anti-CD20 antibody). In some aspects, reagents for a cell-based assay include a cell (e.g., mammalian, bacterial, yeast cell, or the like). In some aspects, the cell is an adherent cell (e.g., a solid tumor-derived cell). In some aspects, the cell is a suspension cell (e.g., red blood cell (RBC), white blood cell (WBC), circulating tumor cell (CTC), or the like). In some aspects, the cell is a mammalian cell (e.g., a human, primate, hamster, mouse, rat and the like). In some aspects, the cell is a yeast cell. In some aspects, the cell is a bacterial cell (e.g., gram-positive or negative). In some aspects, the cell is a recombinant cell. In some aspects, the cell-based assay is a reporter gene-assay. In some aspects, the reporter-gene is luciferase. In some aspects, the cell-based assay is a cell-enumeration assay. In some aspects, the cell-based assay reagent is a dried reagent (e.g., to facilitate long-term storage). In some aspects, the cell-based assay reagent is in solution (e.g., dissolved in an aqueous buffer, organic solvent or a tissue culture medium).

In some aspects, one or more of the different pluralities of wells include one or more reagents for a homogeneous assay. In some aspects, the homogeneous assay is a biochemical assay. In some aspects, the homogeneous assays is a cell-based assay using suspension cells.

In some aspects, one or more of the different pluralities of wells include one or more reagents for a heterogeneous assay. In some aspects, the reagents for a heterogeneous assay include a bead or a well surface with an immobilized analyte-specific binding reagent (e.g., a covalently bound or physically adsorbed antibody, biotin, or other binding reagent) or a soluble analyte specific binding reagent (e.g., a fluorescence-labeled or enzyme-conjugated antibody, biotin, or other binding reagent).

In some aspects, a first plurality of wells include one or more reagents for a cell-based fluorescence assay (e.g., WBC enumeration). In some aspects, a first plurality of wells include one or more reagents for a cell-based fluorescence assay and a different second plurality of wells include one or more reagents for a fluorescence based biochemical assay (e.g., for blood glucose). In some aspects, the fluorescence based biochemical assay is a homogeneous assay (e.g., for blood glucose). In some aspects, the fluorescence based biochemical assay is a heterogeneous assay (e.g., for insulin, a cytokine, or the like). In some aspects, a first plurality of wells include one or more reagents for a cell-based fluorescence assay, a different second plurality of wells include one or more reagents for a fluorescence based biochemical assay and a different third plurality of wells include one or more reagents for an absorbance based biochemical assay. In some aspects, one or more reagents are dried reagents.

In some aspects, a first plurality of wells include one or more reagents for an absorbance based cellular assay. In some aspects, a first plurality of wells include one or more reagents for an absorbance based cellular assay (e.g., RBC enumeration) and a different second plurality of wells include one or more reagents for a fluorescence based biochemical assay (e.g., for blood glucose). In some aspects, the fluorescence based biochemical assay is a homogeneous assay (e.g., for blood glucose). In some aspects, the fluorescence based biochemical assay is a heterogeneous assay (e.g., for insulin, a cytokine, or the like). In some aspects, a first plurality of wells include one or more reagents for an absorbance based cellular assay, a different second plurality of wells include one or more reagents for a heterogeneous fluorescence based biochemical assay and a different third plurality of wells include one or more reagents for a homogeneous fluorescence based biochemical assay. In some aspects, one or more reagents are dried reagents.

In some aspects, a first plurality of wells include one or more reagents for an absorbance based biochemical assay. In some aspects, a first plurality of wells include one or more reagents for an absorbance based biochemical assay and a different second plurality of wells include one or more reagents for a fluorescence based biochemical assay. In some aspects, the fluorescence based biochemical assay is a homogeneous assay. In some aspects, the fluorescence based biochemical assay is a heterogeneous assay. In some aspects, a first plurality of wells include one or more reagents for an absorbance based biochemical assay, a different second plurality of wells include one or more reagents for a heterogeneous fluorescence based biochemical assay and a different third plurality of wells include one or more reagents for a homogeneous fluorescence based biochemical assay. In some aspects, one or more reagents are dried reagents.

In some aspects, a first plurality of wells include one or more reagents for a fluorescence based biochemical assay. In some aspects, a first plurality of wells include one or more reagents for a fluorescence based biochemical assay and a different second plurality of wells include one or more reagents for an absorbance based biochemical assay. In some aspects, the absorbance based biochemical assay is a homogeneous assay. In some aspects, the absorbance based biochemical assay is a heterogeneous assay. In some aspects, a first plurality of wells include one or more reagents for a fluorescence based biochemical assay, a different second plurality of wells include one or more reagents for a heterogeneous absorbance based biochemical assay and a different third plurality of wells include one or more reagents for a homogeneous absorbance based biochemical assay. In some aspects, one or more reagents are dried reagents.

In certain aspects, the methods of the present disclosure include mixing a sample with one or more reagents and loading the sample into the sample well. The planar substrate is then clamped to the capture assembly, rotated and the mixture analyzed.

In certain aspects, the methods of the present disclosure include loading a sample into the sample well which includes one or more reagents thereby producing a mixture. The planar substrate is then clamped to the capture assembly, rotated and the mixture analyzed.

In certain aspects, the methods of the present disclosure utilize beads having a fluorescently labeled moiety. In some aspects, the method includes mixing a sample and a reagent including beads to produce a mixture and loading the mixture into the sample well. The planar substrate is then clamped to the capture assembly, rotated and the mixture analyzed.

In some aspects, the methods of the present disclosure include collecting a sample from a subject. In some aspects, the sample is collected in a sample container.

In some aspects, the sample container is a sterile container or pod. In some aspects, the sample container is placed onto the detection system by a skilled technician.

In certain aspects, the methods include optionally performing a quality control test on the sample, wherein, if the sample passes the quality control test, the sample is analyzed for analytes interest to the subject, and, if the sample fails the quality control step, the sample is discarded, the analytes of interest are not analyzed, or the results of the analysis of the analytes of interest are not reported to the subject. In some aspects, the quality control test is performed prior to the analysis of analytes of interest to the subject. In some aspects, the quality control analysis is performed parallel to the analysis of analytes of interest to the subject.

In some aspects, the sample is a blood sample. In some aspects, the blood sample is fingerprick blood. In some aspects, the blood sample volume is between about 15 μl and about 150 μl, between about 20 μl and about 125 μl, between about 25 μl and about 100 μl, or between about 50 μl and about 70 μl. In some aspects, the blood sample volume is about 10 μl, about 15 μl, about 20 μl, about 25 μl, about 30 μl, about 35 μl, about 40 μl, about 45 μl, about 50 μl, about 55 μl, about 60 μl, about 65 μl, about 70 μl, about 75 μl, about 80 μl, about μl, about 90 μl, about 95 μl, about 95 μl, or about 100 μl. In some aspects, the blood sample volume is between about 50 μl and about 100 μl. In some aspects, the blood sample volume is about 55 μl. Devices and methods for collecting fingerprick blood are known in the art. Exemplary devices useful for collecting fingerprick blood can include, e.g., devices by Seventh Sense Biosystems (e.g., using TAP Touch-Activated Phlebotomy™ or HemoLink™ technology). In some aspects, fingerprick blood collected from a subject includes less than 20%, less than 15%, less than 10%, less than 5%, less than 3%, less than 2%, or less than 1% interstitial fluid. In some aspects, fingerprick blood collected from the subject includes at least 80%, at least 85%, at least 90%, at least 95%, at least 97%, at least 98%, or at least 99% venous blood. In some aspects, interstitial fluid is not detectable in fingerprick blood collected from the subject.

In some aspects, the blood sample is obtained by venipuncture (e.g., using a needle). In some aspects, the blood sample is collected by a phlebotomist. In some aspects the blood sample is collected with an evacuated tube or a vacuum tube (e.g., Vacutainer® by Becton Dickinson & Co, Vacuette® by Greiner Bio-One GmbH). In some aspects, the blood sample is between about 1 ml and about 50 ml, between about 5 ml and about 30 ml and between about 10 ml and about 20 ml. In some aspects, the blood sample is about 15 ml. In some aspects, the blood sample is an aliquot from a larger sample, e.g., an aliquot between about 1 μl and about 250 μl, between about 5 μl and about 200 μl, between about 10 μl and about 175 μl, between about 15 μl and about 150 μl, between about 20 μl and about 125 μl, between about 25 μl and about 100 μl, or between about 50 μl and about 70 μl. In some aspects, the aliquot is between about 1 μl and about 10 μl. In some aspects, the aliquot is between about 50 picoliter (50 μl) and about 100 nanoliter (100 nl).

In some aspects, the methods further include centrifuging the sample.

In some aspects the methods further include diluting the sample. In some aspects, the sample is diluted in a multiwell plate provided herein. In some aspects, the sample is diluted and transferred to a sample well of a planar substrate provided herein. In some aspects, diluting the sample includes preparing a serial dilution of the sample. In some aspects, sample dilutions are prepared, e.g., using a piezoelectric or an acoustic liquid handling device (e.g., Labcyte Echo®).

In some aspects, diluting the sample includes preparing a serial dilution of the sample. In some aspects, the serial dilution includes a serial 2-fold, 3-fold, 5-fold or 10-fold dilution, such as serial 2-point, 3-point, 4-point, 5-point, 6-point, 7-point, 8-point, 9-point, 10-point, 11-point or 12-point dilution. In some aspects, the sample is not diluted serially, e.g., a sample dilution series can include a 1:3, 1:5, 1:10, 1:100, and a 1:500 dilution of sample. In some aspects, the dilution factors or numbers of dilutions in a dilution series are dependent on which two or more analytes of interest to the subject are selected.

In some aspects, the methods provided herein include a seamless integration of sample collection from the patient (e.g., fingerprick) to sample preparation (e.g., centrifugation, bulk sample dilution, dispensing of sample into multiwell plate), sample testing (e.g., start of biochemical or cell-based assays in multiwell plate) and the reporting of test results to the subject. In some aspects, sample preparation begins within 60 min, within 45 min, within 30 min, within 20 min, within 15 min, within 10 min, within 5 min, within 3 min, or within 1 min following sample collection. In some aspects, sample testing in a multiwell plate (e.g., a traditional plate or a multiwell plate provided herein) begins within 60 min, within 45 min, within 30 min, within 20 min, within 15 min, within 10 min, within 5 min, within 3 min, or within 1 min following sample collection. In some aspects, sample testing begins within 60 min, within 45 min, within 30 min, within 20 min, within 15 min, within 10 min, or within 5 min following sample collection. In some aspects, sample testing is completed within 12 hrs, within 10 hrs, within 8 hrs, within 6 hrs, within 4 hrs, within 3 hrs, within 2 hrs, within 90 min, within 60 minutes, within 45 min, within 30 min, or within 20 min following sample collection. In some aspects, test results are communicated to the customer (e.g., by email) or accessible in a database within 12 hrs, within 10 hrs, within 8 hrs, within 6 hrs, within 4 hrs, within 3 hrs, within 2 hrs, within 90 min, within 60 minutes, within 45 min, within 30 min, or within 20 min from sample collection.

In some aspects, the sample is a biological sample obtained from a subject. In some aspects, the biological sample is a liquid sample. In some aspects, the liquid sample is a blood sample (e.g., whole blood, plasma, or serum), a urine sample, or any other body fluid (e.g., amniotic fluid, bile, breast milk, cerebrospinal fluid, gastric acid, lymph, mucus (e.g., nasal drainage or phlegm), pericardial fluid, peritoneal fluid, pleural fluid, pus, rheum, saliva, semen, sputum, synovial fluid, sweat, tears, vaginal secretion, vomit, and the like).

The sample can be obtained non-invasively or invasively. Invasive sample collection can include, e.g., sample collection using an intravenous or hypodermic needle. In some aspects, the sample can be obtained by fingerprick using a fingerprick device. Fingerprick devices that can be used in the methods provided herein include, without limitation, a TAP Touch Activated Phlebotomy™ device by Seventh Sense Biosystems or a HemoLink™ device by Tasso, Inc.

In some aspects, the subject is a human patient having a disease, disorder, or other condition (e.g., a metabolic disease, a genetic disorder, an inflammatory disease, an autoimmune disease, a neurodegenerative disorder, a psychiatric disorder and the like).

In some aspects, the sample is a human blood sample. In some aspects, the human blood sample is obtained using a fingerprick device.

Analytes, or clinical parameters, that can be analyzed using the sample analyzer or methods described herein can include analytes or clinical parameters related to a subject's disease condition, a subject's general health status, wellness or life-style, a subject's genotype, or combinations thereof.

The analytes described herein can include any molecular or cellular component of a biological sample. In some aspects, analytes include a protein (e.g., PSA), a nucleotide (e.g., an mRNA expression level or DNA sequence), a sugar (e.g., glucose, or a posttranslational protein modification), a lipid (e.g., triglycerides) or lipid particle (e.g., LDL, HDL, VLDL, and the like), a metabolite (e.g., lactate, pyruvate), a metal ion or mineral (e.g., Na+, Fe2+), a vitamin (e.g., ascorbic acid), a cell (e.g., white blood cell, platelet, virus, pathogen cell, such as a bacterium or a eukaryotic pathogen), or combinations thereof. Analytes can be analyzed qualitatively (e.g., presence or absence) or quantitatively (e.g., analyte concentration or number of analytes per volume). Analyte concentrations can be expressed in absolute terms (e.g., analyte concentration in a sample) or relatively (e.g., percent of a population).

In some aspects, a subject's disease condition can include, e.g., without limitation, a metabolic disorder (e.g. diabetes, obesity, metabolic syndrome, and the like), a liver disease (e.g., cirrhosis), a kidney disease (e.g., acute or chronic kidney disease, kidney cancer), a pancreas disease (e.g., acute pancreatitis, chronic pancreatitis, hereditary pancreatitis, pancreas cancer), an inflammatory disorder (e.g., rheumatoid arthritis, inflammatory bowel disease), a cardiovascular disorder (e.g., angina, myocardial infarction, stroke, atherosclerosis), an immune or autoimmune disorder (e.g., lupus erythematosus, celiac disease), a cancer (e.g., multiple myeloma, lymphoma, leukemia, prostate cancer, breast cancer, and the like), an infectious disease (e.g., Lyme Disease, HIV, sexually transmitted diseases (STDs), and the like), an endocrine disorder (e.g., Cushing's Syndrome, Growth Hormone Deficiency), a blood disorder (e.g., anemia, a bleeding disorder, such as hemophilia, or blood cancer), a psychiatric or behavioral disorder or condition (e.g., attention deficit disorder), and others.

In some aspects, analytes or clinical parameters relating to a subject's disease condition can include, e.g., without limitation, adenovirus DNA, alanine aminotransferase (ALT/SGPT), albumin, alkaline phosphatase (ALP), alpha-1-acid glycoprotein, alpha-1-antitrypsin (e.g., total), alpha-fetoprotein (AFP), amphetamines, amylase, red blood cell (RBC) antibody, antinuclear antibodies (ANA), apolipoprotein (e.g., apo A-1, apo B), aspartate aminotransferase (AST/SGOT), B-cell count, beta-2 microglobulin, bilirubin (e.g., direct or total), blood urea nitrogen (BUN), borrelia antibody, brain natriuretic peptide (BNP), calcitonin, calcium (e.g., blood, urine), cancer antigens (e.g., CA 125, CA 15-3, CA 27.29, CA 19-9), carbon dioxide, carcinoembryonic antigen (CEA), cardiolipin antibody (ACA, e.g., IgG), complete blood count (CBC), CD4 or CD8 counts (e.g., absolute counts or ratios), chlamydia tachomatis, chloride (e.g., blood, urine), cholesterol, cholinesterase, complement component 3 or 4 antigens, cortisol (e.g., total), C-peptide, C-reactive protein (CRP, e.g., CRP-High Sensitivity (hsCRP)), creatine kinase, creatinine (e.g., blood or urine), cyclic citrullinated peptide (CCP) antibody, IgG, cystatin C, cytomegalovirus (CMV) antibody (e.g., IgG or IgM), D-dimer, deamidated gliadin peptide (DGP) antibody (e.g., IgA or IgG), dehydroepiandrosterone sulfate (DHEA-5), deoxypyridinoline crosslinks (DPD) (collagen crosslinks, e.g., urine), double-stranded DNA (dsDNA) antibody (e.g., IgG), E. coli Shiga-like toxin, EBV early D Antigen (EA-D), EBV nuclear antibody, EBV viral capsid antigen (VCA), EBV viral capsid antigen (VCA), endomysial antibody (EMA, e.g., IgM or IgG), erythrocyte sedimentation rate, extractable nuclear antigen antibodies (ENA panel) (RNP, Smith, SSA, SSB, SCO-70, JO-1), ferritin, fibrinogen, gastrin, glucose, growth hormone (HGH), Helicobacter pylori (H. pylori), IgG, hematocrit (HCT), hemoglobin (HGB), hemoglobin A1c (HbA1c), hepatitis A (HAV) antibody (e.g., IgM, total), hepatitis B (HBV) core antibody (e.g., IgM, total), hepatitis B (HBV) surface antibody, hepatitis B (HBV), DNA, hepatitis C (HCV) antibody, hepatitis C (HCV) genotype, hepatitis C (HCV), RNA, HER-2/neu, herpes simplex 1 (HSV1), herpes simplex 2 (HSV2), high-density lipoprotein (HDL), human immunodeficiency virus 1 (HIV-1), HIV-1/HIV-2, homocysteine, immunoglobulins (e.g., IgA, IgG, IgM, IgE, IgG, IgM), IGF-1 (insulin-like growth factor 1), insulin, iron, iron binding capacity (IBC; e.g., total (TIBC)), lactate dehydrogenase, lead, lipase, low-density lipoprotein (LDL), lymphocyte enumeration, magnesium, measles, mumps, and rubella (MMR) immunity, microalbumin (e.g., urine), myoglobin, Neisseria gonorrhea (e.g., DNA), natural killer cells (NKC), ova & parasites, parathyroid hormone (PTH), partial thromboplastin time (PTT), phosphorus, inorganic, platelets, potassium (e.g., blood, urine), prealbumin, prostate specific antigen (PSA, e.g., free or total), protein (e.g., total, e.g.; blood or urine), prothrombin pime (PT/INR), red blood cell count (RBC), reticulocyte count (RC), rheumatoid factor (e.g., total), rubella (Measles) antibody (e.g., IgG or IgM), sex hormone-binding globulin (SHBG), sodium (e.g., blood or urine), streptolysin 0 antibody (ASO; e.g., titer), T-cell (e.g., total count), triiodothyronine, thyroglobulin, thyroglobulin antibodies (TAA), thyroid peroxidase (TPO) antibody, thyroid stimulating hormone (TSH), thyroxine binding globulin (TBG), thyroxine (e.g., free T4 or total T4), tissue transglutaminase (tTG) antibody (e.g., IgA or IgG), toxoplasma (e.g., IgG or IgM), transferrin, triglycerides, triiodothyronine (e.g., free T3 or total T3), troponin I (tCNI), tuberculosis, uric acid, Varicella-zoster (VZV) antibody, and white blood cell count (WBC).

In some aspects, a subject's general health status, wellness or life-style can include or be affected by, e.g., without limitation, allergies/hypersensitivities, blood pressure, body weight (e.g., body-mass-index), diet (e.g., Western diet, Mediterranean diet, processed foods, home-cooked meals), drinking habits (e.g., frequency, quantity, or type of alcohol consumption), drug use (e.g., prescription drugs, recreational drugs, doping), environmental factors (e.g., pollution, climate), exercise habits (e.g., frequency, intensity, type of exercise), fertility, pregnancy, rest period (e.g., day or night-time, duration, frequency), smoking habits, stress levels (e.g., chronic, acute), vacation schedule, work schedule, and other factors.

In some aspects, analytes or clinical parameters relating to a subject's general health status, wellness or life-style can include, e.g., without limitation, ACTH (corticotropin), alpha-fetoprotein (AFP; e.g., maternal), amphetamine, androstenedione, anti-mullerian hormone (AMH), apolipoprotein (e.g., apo A-1, apo B), barbiturates (e.g., urine), benzodiazepines (e.g., urine), cortisol (e.g., total), cyclosporine A, ecstasy (MDMA), estradiol, estriol (e.g., unconjugated), estrone, ethanol, folate (folic acid), follicle stimulating hormone (FSH), gamma-glutamyltransferase (GGT), glucose, hCG-chorionic gonadotropin (e.g., blood or urine, qualitative or quantitative), insulin, lithium, low-density lipoprotein (LDL), marijuana (THC), methadone (dolophine), methamphetamines, opiates, phencyclidine (PCP), progesterone, prolactin, propoxyphene, testosterone (e.g., free or total), tricyclic antidepressants (e.g., urine), vitamin B-12, vitamin D 25-OH.

In some aspects, a subject's genotype can include genes related to a subject's health or disease conditions (e.g., life expectancy, disease susceptibility), or other physical or mental traits (e.g., energy level, athletic abilities, intelligence). In some aspects, a subject's genotype can include genes related to a subject's ancestry (e.g., family ties, geographic origins).

In some aspects, the analytes, or clinical parameters, that can be analyzed using the sample analyzer or methods described therein can include a biomarker (e.g., biomarker level in a patient) analyzed in connection with a pharmaceutical treatment of a patient, e.g., a small molecule drug or biotherapeutic (e.g., an antibody or other recombinant protein) treatment. In some aspects, the biomarker is analyzed in the course of a clinical trial, e.g., to analyze the efficacy of an clinical drug candidate in a patient, to analyze a patient's compliance with the treatment regimen, or to select a patient who may benefit from the treatment.

In some aspects, analysis includes analysis of red blood cells (RBC; e.g., RBC count), platelets (e.g., platelet count), or white blood cells (WBC; e.g., WBC count). In some aspects, the WBC includes the totality of WBCs in a blood sample (e.g., cluster of differentiation 45 (CD45)-positive cells, e.g., CD45RA-isotype or CD45RO-isotype; e.g., total WBC count). In some aspects, the WBC includes a T-cell (e.g., cluster of differentiation 3 (CD3)-positive cells), a B-cell (e.g., cluster of differentiation 19 (CD19)-positive cells), a natural killer (NK) cell (e.g., CD3-negative and cluster of differentiation 16 (CD16) and cluster of differentiation 56 (CD56)-positive cells), or combinations thereof. In some aspects, the T-cell includes a T-helper cell (e.g., CD4-positive cells) or a cytotoxic T-cell (e.g., CD8-positive cells). In some aspects, T-helper cells or cytotoxic T-cells can be further classified into naive cells (e.g., CD4RA+ or CD8 RA+), or memory cells (e.g., CD4RO+ or CD8RO−). In some aspects, the blood cell panel includes a circulating tumor cell (CTC; e.g., CTC count). In some aspects, the CTC includes a traditional CTC (e.g., CD45-negative, creatine kinase (CK)-positive cell with intact nucleus), a cytokeratin negative (CK) CTC (e.g., CD45-negative cell with cancer cell-like morphology), a small CTC (e.g., a CD45-negative cell with a size and morphology similar to an average WBC), or a CTC cluster (e.g., two or more CTCs bound together, e.g., cluster of traditional, CK-negative or small CTCs). In some aspects, the blood cell panel includes CD45 (e.g., CD45RA or CD45RO, or both), CD3, CD16, CD56, CD4, CD8, CK, cell morphology (e.g., cell size or shape, tumor cell-like or WBC-like phenotype or appearance, intact or apoptotic nucleus, and the like), or combinations thereof.

In some aspects, analysis complete blood cell (CBC) analysis including white blood cell count (WBC), white blood cell differential (DIFF), absolute neutrophil count, % neutrophils (Neu, PMN, polys), absolute lymphocyte count, % lymphocytes (Lymph), absolute monocyte count, % monocytes (Mono), absolute eosinophil count, % eosinophils (EOS), absolute basophil count, % basophils (BASO), red blood count (RBC), red blood cell distribution (RDW), hemoglobin (Hb), hematocrit (Hct), mean corpuscular volume (MCV), mean corpuscular hemoglobin (MCH), mean corpuscular hemoglobin concentration (MCHC), platelet count (PIT), mean platelet volume (MPV), or combinations thereof.

Analytes, or clinical parameters, that can be analyzed using the multiwell plates, systems, or methods described therein can include analytes present at a wide range of different concentrations in a sample (e.g., a blood sample or urine sample). Analytes can include high-abundance analytes, medium-abundance analytes, and low-abundance analytes. In some aspects, high-abundance analytes include analytes present in a sample at concentrations of >100 μM, e.g., >500 μM, >1 mM, >2 mM, >3 mM, >4 mM, >5 mM, >6 mM, >7 mM, >8 mM, >9 mM, >10 mM, >15 mM, >20 mM, >25 mM, >50 mM, >75 mM, >100 mM, >125 mM, >150 mM, or >200 mM. In some aspects, medium abundance analytes include analytes present in a sample at concentrations between 100 nM and 100 μM (e.g., between 100 nM and 1 μM, between 1 μM and 10 μM, or between 10 μM and 100 μM). In some aspects, low abundance analytes include analytes present in a sample at concentrations of <100 nM, such as <10 nM, <1 nM, <100 μM, <10 μM, or <1 μM.

In some aspects, the sample analyzer further includes a sample dilution station. In some aspects, the sample dilution station includes a liquid handling device capable of preparing a dilution or dilution series of a small sample volume (e.g., 1-200 μl of a human blood sample). In some aspects, the sample dilution station is includes a sample dilution plate (e.g., a disposable traditional multiwell) and a multiwell plate provided herein. In some aspects, the sample dilution station includes a liquid handling device capable of transferring an aliquot of a sample or of a sample dilution from the sample dilution plate to a multiwell plate provided herein. In some aspects, the liquid handling device is capable of preparing a sample dilution series directly in the multiwell plate provided herein.

In some aspects, the sample analyzer includes an operator interface having a data entry device, a display, and, optionally, a barcode reader.

In some aspects, the processor controls operation of the sample dilution station.

In some aspects, the sample analyzer includes an operator interface (e.g., for a skilled technician), having a data entry device (e.g., keyboard, touchscreen, a voice recognition device), a display (e.g., computer screen), and, optionally, a barcode reader.

Although the invention has been described with reference to the above examples, it will be understood that modifications and variations are encompassed within the spirit and scope of the invention. Accordingly, the invention is limited only by the following claims.

1. An assembly comprising:
a) a clamp mechanism configured to clamp and secure a planar substrate, the clamp mechanism comprising:
i) a hub for contacting a bottom surface of the planar substrate, the hub comprising one or more elements disposed on an upper surface of the hub configured to engage the bottom surface of the planar substrate and position the planar substrate on the upper surface of the hub in a plane of rotation; and
ii) a clamping portion configured to reversibly contact a top surface of the planar substrate,
wherein the clamping portion is operable to reversibly transition from a first configuration to a second configuration,
wherein when in the first configuration, the clamping portion is not in contact with the top surface of the planar substrate, and
wherein when in the second configuration, the clamping portion is in contact with the top surface of the planar substrate thereby clamping the planar substrate between the upper surface of the hub and the clamping portion; and
b) a drive shaft having a longitudinal axis, the shaft being operably coupled to the hub and operable to rotate the planar substrate in the plane of rotation.

2. (canceled)

3. The assembly of claim 1, wherein the hub has a perimeter disposed about the longitudinal axis of the shaft and a through-hole within the perimeter of the hub extending through the hub along the longitudinal axis of the shaft.

4. (canceled)

5. The assembly of claim 1, wherein the clamping portion comprises a first member that has a flange configured to contact the top surface of the planar substrate when the clamping portion is in the second configuration.

6. The assembly of claim 5, wherein the clamping portion comprises a second member that has a shaft that extends along the longitudinal axis of the drive shaft and has an expanded diameter region configured to contact the first member when in the second configuration to cause the flange to contact the top surface of the planar substrate.

7. The assembly of claim 6, wherein the clamping portion comprises a third member having a flange configured to contact the top surface of the planar substrate when the clamping portion is in the second configuration.

8. The assembly of claim 7, wherein the expanded diameter region is configured to contact the third member when in the second configuration to cause the flange of the third member to contact the top surface of the planar substrate.

9. (canceled)

10. The assembly of claim 5, further comprising a support platform for supporting the planar substrate.

11. The assembly of claim 10, wherein the assembly is operable to reversibly transition from a first position to a second position,
wherein when the assembly is in the first position, the platform is in contact with the planar substrate and the hub is not in contact with the planar substrate, and
wherein when the assembly is in a second position, the platform is not in contact with the planar substrate and the hub is in contact with the planar substrate.

12. The assembly of claim 11, further comprising a clamp release arm operable to transition the clamping portion from the first configuration to the second configuration during transition of the assembly from the first position to the second position.

13. The assembly of claim 12, wherein when the clamping portion is in the second configuration, the assembly is in the second position and the clamp release arm is disengaged.

14. The assembly of claim 13, further comprising a spring operable to tension the one or more elements of the hub against the bottom surface of the planar substrate when the clamping portion is in the second configuration.

15. The assembly of claim 14, further comprising a motor operable to reversibly move the assembly from the first position to the second position.

16. The assembly of claim 15, further comprising a processor operable to control movement of the assembly from the first position to the second position.

17. (canceled)

18. The assembly of claim 1, wherein the hub is a disc having a centrally located through-hole.

19. The assembly of claim 18, wherein the one or more elements are disposed within a circumference of the hub.

20. (canceled)

21. The assembly of claim 19, wherein the elements are disposed on the top surface of the hub radially about the longitudinal axis of the shaft.

22. (canceled)

23. The assembly of claim 19, wherein each element is shaped such that adjacent elements form a groove operable to engage an element disposed on the bottom surface of the planar substrate.

24. The assembly of claim 23, wherein the element of the planar substrate is disposed within the groove in the second configuration and is in contact with the adjacent elements.

25. The assembly of claim 23, wherein each element includes a tapered surface, wherein the tapered surface of each adjacent element forms the groove.

26. The assembly of claim 1, further comprising
a motor operably coupled to the shaft, wherein the motor is configured to rotate the planar substrate in the plane of rotation; and
a processor configured to control a rate of rotation of the motor.

27-59. (canceled)
